(19) United States
(12) Patent Application Publication
(10) Pub. No.: US 2012/0290144 A1
(43) Pub. Date: Nov. 15, 2012

(54) POWER MANAGEMENT DEVICE AND POWER MANAGEMENT METHOD, AS WELL AS POWER MANAGEMENT SYSTEM PROVIDED WITH POWER MANAGEMENT DEVICE, HOUSE PROVIDED WITH POWER MANAGEMENT SYSTEM, PROGRAM FOR POWER MANAGEMENT DEVICE, AND COMPUTER READABLE RECORDING MEDIUM

(75) Inventors: Natsuki Yuasa, Osaka-shi (JP); Mitsunori Nojima, Osaka-shi (JP)

(73) Assignee: SHARP KABUSHIKI KAISHA, Osaka-shi, Osaka (JP)

(21) Appl. No.: 13/575,194

(22) PCT Filed: Jan. 25, 2011
(86) PCT No.: PCT/JP2011/051331

§ 371 Date: Jul. 25, 2012

(30) Foreign Application Priority Data
Jan. 29, 2010 (JP) 2010-019373

(51) Int. Cl. G05F 5/00

(52) U.S. Cl. 700/295

(57) ABSTRACT

In an electric power management advising device, advice generated by the advice generating section and related to electric power saving is outputted by the advice outputting section. On the basis the advice thus generated, the collective control executing section carries out controls of the respective plurality of devices collectively. Accordingly, a user is provided with the advice related to electric power saving, and the plurality of devices are collectively controlled on the basis of the advice. That is, when the user wants to adopt the advice provided to the user, the user does not have to handle an operation himself. This keeps the user free from inconvenience. Therefore, it becomes possible to achieve an electric power saving effect reliably and provide a more comfortable and enriched life to the user.

### TECHNICAL FIELD

The present invention relates to (i) an electric power management device and an electric power management method for managing electric power of devices provided in a house, (ii) an electric power management system including the electric power management device, (iii) a house including the electric power management system, (iv) a program for the electric power management device, and (v) a computer-readable recording medium.

### BACKGROUND ART

In recent years, there has been a tendency towards increased electric power consumption by electronic devices such as a television receiver, as the devices have an increased size and a higher performance. On the other hand, a demand for cleaner energy is growing out of a problem of depletion of energy resources and a problem related to global environment such as the global warming resulting from increased CO₂ in the atmosphere. In response to this, solar cells in particular, in which photovoltaic power generation is utilized, is being developed as a new type of energy source and is beginning to be put to practical use.

In response to the spread of the solar cells in ordinary households, a grid-connected and dispersed photovoltaic power generation device has been developed. The grid-connected and dispersed photovoltaic power generation device makes combined use of (i) a dispersed electric power source that provides electric power generated by solar cells and (ii) a commercial electric power source. The grid-connected and dispersed photovoltaic power generation device is capable of supplying necessary electric power from the commercial electric power source, in a case where necessary electric power cannot be supplied by the dispersed electric power source alone. For the purpose of improving utility of the grid-connected and dispersed photovoltaic power generation device, there has recently been developed a grid-connected photovoltaic power generation device having additional new functions.

For example, Patent Literature 1 discloses a photovoltaic power generation device that displays (i) an amount of electric power generated by solar cells and (ii) an amount of electric power consumed by the user. This makes it possible to check at a glance a relation between an amount of electric power generated by the solar cells and an amount of electric power consumed by the user at the moment. The photovoltaic power generation device disclosed in Patent Literature 1 has a function of displaying, in a case where an amount of electric power generated by the solar cells of the photovoltaic power generation device is 20% lower than, for example, an average amount of electric power generated by other photovoltaic power generation devices installed in an area in which the photovoltaic power generation device is installed, advice information that recommends checking whether or not the solar cells have some problem. The photovoltaic power generation device also has a function of displaying, on the basis of an amount of electric power generated and an amount of electric power consumed, advice information related to a bill to be paid by the user to an electric power company that provides the commercial electric power source. These functions allow the user to (i) check whether the photovoltaic power generation device has some trouble or (ii) take an action for reducing electric power consumption, based on advice information that is displayed.

Patent Literature 2 also discloses a photovoltaic power generation device that displays (i) an amount of electric power generated by solar cells and (ii) an amount of electric power consumed by the user. The photovoltaic power generation device has a function of displaying amounts of electric power consumed by respective household electric appliances in a house. Based on this, with respect to a household electric appliance with high electric power consumption, advice information related to a cause of the high electric power consumption is displayed. The photovoltaic power generation device also has a function of displaying advice information that recommends buying a household electric appliance of a new model (model with lower electric power consumption) to replace the household electric appliance having the high electric power consumption. At this time, an economic benefit that will be given to the user through the replacement is displayed as well. According to these functions, the user can reduce electric power consumption by taking actions in accordance with various pieces of advice information.

### CITATION LIST

### Patent Literature

Patent Literature 1
Japanese Patent Application Publication, Tokukai, No. 2002-101554 A (Publication Date: Apr. 5, 2002)

### Patent Literature 2

Japanese Patent Application Publication, Tokukai, No. 2003-259551 A (Publication Date: Sep. 12, 2003)

### SUMMARY OF INVENTION

### Technical Problem

The photovoltaic power generation devices disclosed in Patent Literature 1 and 2 display advice information for reducing electric power consumption. However, what is displayed here is mere advice information that recommends reducing electric power consumption. In order to actually achieve reduction in electric power consumption, it is necessary that the user himself take an action in accordance with the advice. For example, in a case where the user is advised to switch off a household electric appliance, the user has to handle an operation of switching off the household electric appliance himself. It is thus necessary for the user to handle an operation himself when the user wants to adopt given advice. The user may feel this inconvenient. In some cases, the user may even feel like the user is being forced to act in accordance with the displayed advice information.

The present invention is accomplished in view of the problem. An object of the present invention is to provide (i) an electric power management device and an electric power management method for presenting advice related to electric power saving to a user while causing no inconvenience to the user when a device is actually controlled in accordance with the advice, (ii) an electric power management system including the electric power management device, (iii) a house including the electric power management system, (iv) a program for the electric power management device, and (v) a computer-readable recording medium.

### Solution to Problem

In order to attain the object, an electric power management device in accordance with the present invention is an electric power management device including: advice generating means for generating advice related to electric power saving; advice outputting means for outputting the advice; and control executing means for carrying out controls of the respective plurality of devices collectively in accordance with the advice.

According to the configuration, advice generated by the advice generating means and related to electric power saving can be outputted by the advice outputting means. On the basis of the advice thus generated, the control executing means can carry out controls of the respective plurality of devices collectively. Accordingly, the user is provided with the advice related to electric power saving, and the plurality of devices are collectively controlled on the basis of the advice.

Although a device that provides the user with advice related to electric power saving has been conventionally disclosed, such device merely provides the user with the advice related to electric power saving. In order to actually achieve electric power saving, the user has to take an action himself in accordance with the advice. As such, when the user wants to adopt the advice provided to the user, the user may feel it inconvenient that the user has to carry out an operation in accordance with the advice. The electric power management device in accordance with the present invention, however, is capable of not only providing the user with the advice related to electric power saving but also carrying out controls of the respective plurality of devices collectively in accordance with the advice. That is, the user does not have to handle an operation when the user wants to employ the advice provided to the user. This keeps the user free from inconvenience. Therefore, it becomes possible to achieve an electric power saving effect reliably and provide a more comfortable and enriched life to the user.

In order to attain the object, an electric power management method in accordance with the present invention is an electric power management method including: generating advice related to electric power saving; outputting the advice; and carrying out controls of the respective plurality of devices collectively in accordance with the advice.

The method can bring about an effect similar to that brought about by the electric power management device in accordance with the present invention.

The electric power management device in accordance with the present invention further includes state obtaining means for obtaining a state of at least one of the plurality of devices, the advice generating means generating the advice in accordance with the state obtained by the state obtaining means.

According to the configuration, the user is provided with advice to which a device state of at least one of the plurality of devices is reflected. On the basis of the advice, a specific one of the plurality of devices can be collectively controlled.

In order to attain the object, an electric power management system in accordance with the present invention is an electric power management including any one of the electric power management devices described above and the plurality of devices.

According to the configuration, it is possible to provide an electric power management system that not only provides the user with advice related to electric power saving but also collectively controls a plurality of devices on the basis of the advice, thereby providing a more comfortable and enriched life to the user.

In order to attain the object, a house in accordance with the present invention includes the electric power management system.

According to the configuration, it is possible to realize a house that not only provides the user with advice related to electric power saving but also collectively controls a plurality of devices on the basis of the advice, thereby providing a more comfortable and enriched life to the user.

Note that the electric power management device can be realized by use of a computer. In this case, (i) a program for causing the computer to operate as each section of the electric power management device so as to realize the electric power management device by use of the computer and (ii) a computer-readable recording medium in which the program is recorded, are also included in the scope of the present invention.

Additional objects, features, and strengths of the present invention will be made clear by the description below. Further, the advantages of the present invention will be evident from the following explanation in reference to the drawings.

### Advantageous Effects of Invention

An electric power management device in accordance with the present invention provides the user with advice related to electric power saving. In addition to providing the advice to the user, the electric power management device is capable of controlling a plurality of devices collectively on the basis of the advice. That is, the user does not have to handle an operation himself when the user wants to adopt the advice provided to the user. This keeps the user free from inconvenience. Therefore, it becomes possible to achieve an electric power saving effect reliably and provide a more comfortable and enriched life to the user.

### BRIEF DESCRIPTION OF DRAWINGS

FIG. 1 is a view showing a configuration of an electric power management system in accordance with an embodiment of the present invention.

FIG. 2 is a schematic view illustrating an arrangement of a house in accordance with an embodiment of the present invention.

FIG. 3 is a view showing details of information registered in a device information database in accordance with an embodiment of the present invention device.

FIG. 4 is a view showing an example of how advice is displayed in a case where the advice is displayed on a TV.

FIG. 5 is a view showing an example of how advice is displayed in a case where the advice is displayed on a TV.

FIG. 6 is a view showing an example of how advice is displayed in a case where the advice is displayed on a mobile phone.

FIG. 7 is a view showing an example of how advice is displayed in a case where the advice is displayed on a TV.

FIG. 8 is a view showing an example of what is displayed on a TV screen in a case where a condition of a trigger is changed.

FIG. 9 is a view showing an example of what is displayed on a TV screen in a case where sentences of advice to be displayed are changed.

FIG. 10 is a view showing an example of what is displayed on a TV screen in a case where a content of collective control is changed.

### DESCRIPTION OF EMBODIMENTS

### Arrangement of House 2

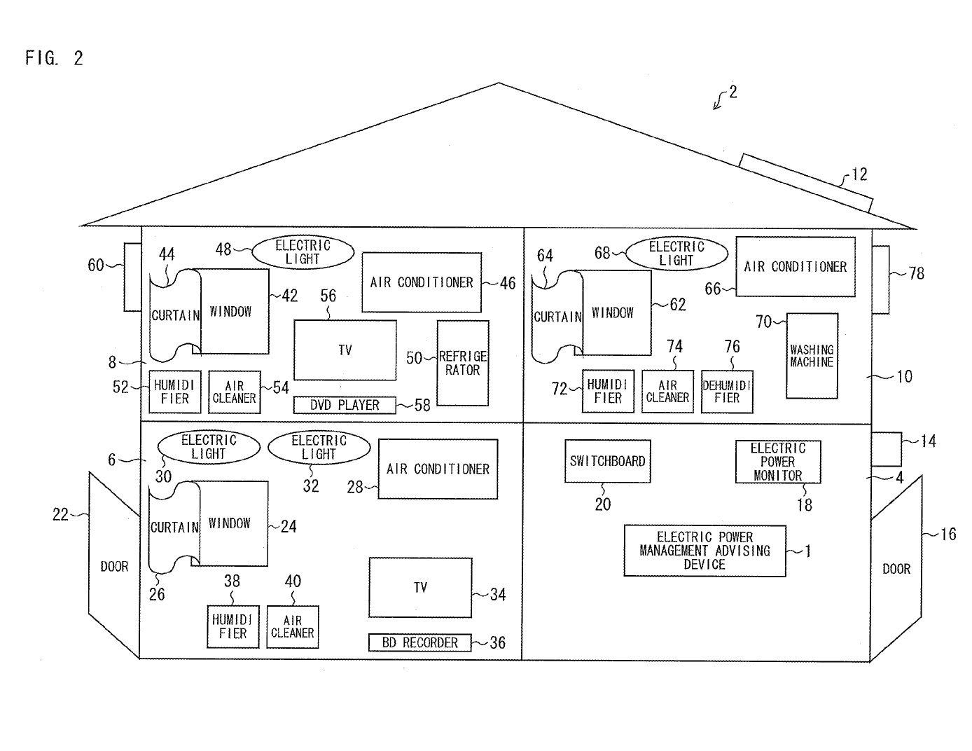

The following description will discuss, with reference to FIG. 2, details of an arrangement of a house 2 in accordance with the present embodiment. FIG. 2 is a schematic view illustrating an arrangement of a house 2 in accordance with an embodiment of the present invention.

As illustrated in FIG. 2, the house 2 includes a living room 6, a dining and kitchen room 8, a children's room 10, a corridor 4, and an entrance (not shown). Further, the house 2 is externally provided with a photovoltaic power generation device 12 on a roof and the like, and is provided with a power conditioner 14 for the photovoltaic power generation device 12. The house 2 has a door 22 leading to the outside of the house 2, as well as an entrance door 16. The entrance door 16 of the house 2 leads to the corridor 4, in which an electric power management advising device (electric power management device) 1, an electric power monitor 18, and a switchboard 20 are provided.

In the living room 6, (i) electric lights 30 and 32, (ii) a window 24 having a curtain 26, (iii) an air conditioner 28, (iv) a humidifier 38, (v) an air cleaner 40, (vi) a TV 34, and (vii) a BD recorder 36 are provided. The living room 6 is connected with the corridor 4 via a door 86 (not shown) and with the dining and kitchen room 8 via a door 80 (not shown).

In the dining and kitchen room 8, (i) an electric light 48, (ii) a window 42 having a curtain 44, (iii) a ventilation fan 60, (iv) an air conditioner 46, (v) a humidifier 52, (vi) an air cleaner 54, (vii) a refrigerator 50, (viii) a TV 56, and (ix) a DVD player 58 are provided. The dining and kitchen room 8 is connected with the children's room 10 via a door 82 (not shown).

In the children's room 10, (i) an electric light 68, (ii) a window 62 having a curtain 64, (iii) a ventilation fan 78, (iv) an air conditioner 66, (v) a humidifier 72, (vi) an air cleaner 74, (vii) a dehumidifier 76, and (viii) a washing machine 70 are provided. The children's room 10 is connected with the corridor 4 via a door 84 (not shown).

(Configuration of Electric Power Management System 90)

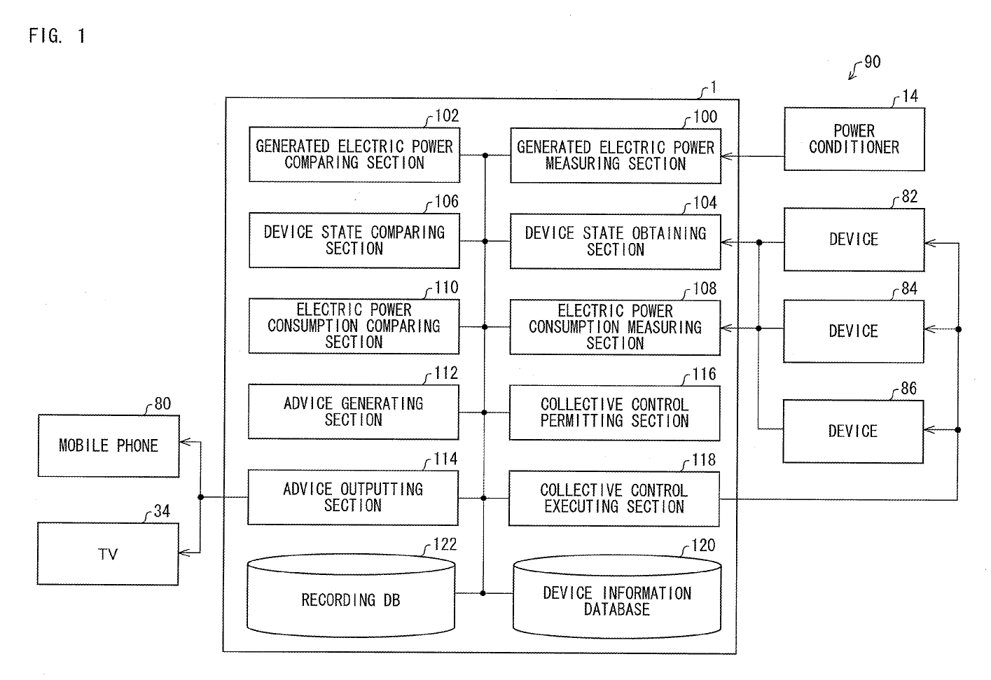

FIG. 1 is a view showing a configuration of an electric power management system 90 in accordance with an embodiment of the present invention. As shown in FIG. 1, the electric power management system 90 includes the electric power management advising device 1, the power conditioner 14, the TV 34, a plurality of devices 82, 84, and 86, and a mobile phone (portable device) 80. Note that FIG. 1 shows only some of devices that constitute the electric power management system 90. In reality, all of the devices illustrated in FIG. 2 constitute the electric power management system 90. In other words, the house 2 includes the electric power management system 90.

The electric power management advising device 1 includes a generated electric power measuring section (generated electric power measuring means) 100, a generated electric power comparing section 102, a device state obtaining section (state obtaining means) 104, a device state comparing section 106, an electric power consumption measuring section (electric power consumption measuring means) 108, an electric power consumption comparing section (comparing means) 110, an advice generating section (advice generating means) 112, an advice outputting section (advice outputting means) 114, a collective control permitting section 116, a collective control executing section (control executing means) 118, a device information database (device information DB) 120, and a recording database (recording DB) 122. Although the advice outputting section 114 in FIG. 1 is connected with the TV 34 and the mobile phone 80, the present embodiment is not limited to this. For example, the advice outputting section 114 can be connected with the electric power monitor 18. Also note that the advice outputting section 114 does not necessarily have to be connected with only one TV, but can be connected with all of the TVs (e.g., the TV 34 and the TV 56) in the house 2. Examples of how advice is supplied to the TVs 34 and 56 are given below.

Examples of how advice is supplied encompass (1) a technique in which the electric power management advising device 1 is connected with one of a plurality of external input terminals of a TV, (2) a technique the advise is transmitted, via a weak radio signal, to a channel on which no TV program is being broadcast, (3) a technique in which the electric power management advising device 1 has a web server function and generates advice data as home page data, and the web server is accessed by the TV via the Internet, (4) a technique in which the TV has a widget function that allows activating an application program while watching TV, and the advice is displayed via the application program, (5) a technique in which the advice is displayed by use of an emergency warning broadcasting system or other system equivalent to the emergency warning broadcasting system, and (6) a technique in which the electric power management advising device 1 has a display, on which the advice is displayed.

The electric power management advising device 1 is connected with each of the devices illustrated in FIG. 2 so as to communicate with the each of the devices. FIG. 1 shows specific ones of the devices connected with the electric power management advising device 1.

Each of the plurality of devices 82, 84, and 86 shown in FIG. 1 corresponds to one (other than the electric power management advising device 1) of the devices illustrated in FIG. 2.

(Content of Device Information DB)

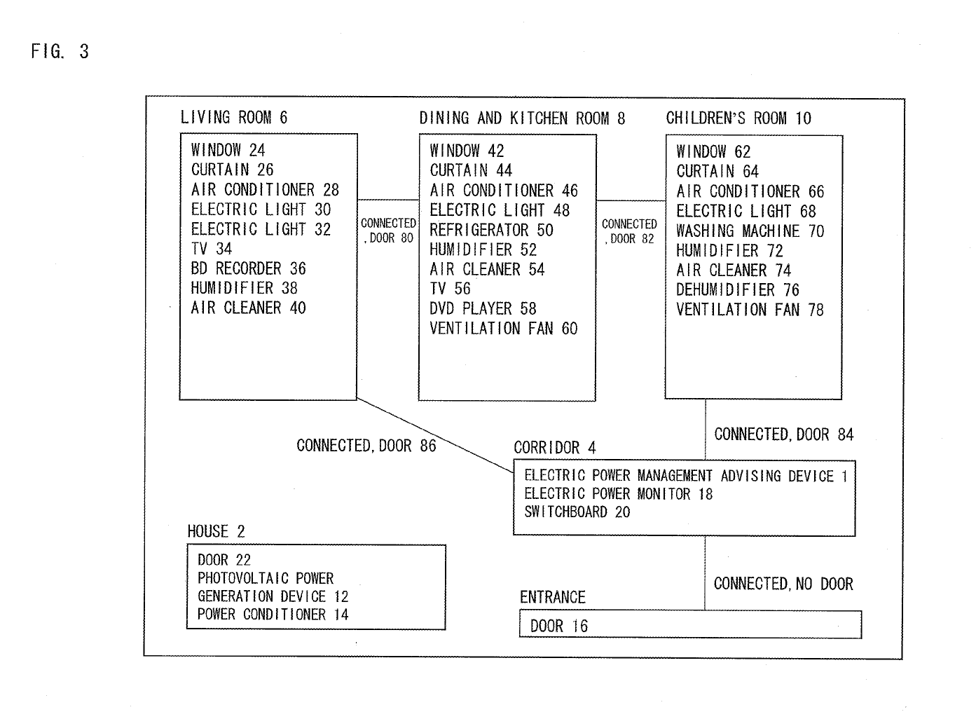

FIG. 3 is a view showing details of information registered in a device information DB 120. As shown in FIG. 3, information that indicates locations (room, corridor, and entrance) of the devices and facilities of the house 2 is stored in advance in the device information DB 120. As such, the electric power management advising device can determine, based on the information registered in the device information DB 120, in which part of the house 2 a device whose state and/or value is to be obtained or a device to be controlled is present.

(Operation of the Electric Power Management System 90)

The following description will discuss an operation of the electric power management system 90 by giving specific examples.

First, the following description will discuss an example of how the electric power management system 90 operates in a case where advice is generated on the basis of a state of a device. The device state obtaining section 104 obtains a current device state of at least one of the plurality of devices 82, 84, and 86. Examples of the device state encompass (i) an on-state or an off-state of each of the devices 82, 84, and 86, (ii) a state of mode (e.g., heating mode and cooling mode) that has been set, (iii) a level (value) (e.g., target temperature) that has been set, and (iv) a value (e.g., measured value of humidity or the like) measured by means of a sensor of each of the devices 82, 84, and 86.

The device state obtained by the device state obtaining section 104 is supplied to the advice generating section 112 and the collective control permitting section 116. On the basis of the device state supplied, the advice generating section 112 generates advice suitable for the device state. The advice generated by the advice generating section 112 is supplied to the advice outputting section 114, and the advice outputting section 114 supplies the advice to the mobile phone 80 or the TV 34. This causes the advice suitable for the device state obtained by the device state obtaining section 104 to be displayed on a screen of the mobile phone 80 or a screen of the TV 34, so that the user can check the advice. The user can determine (instruct), via a remote controller of the mobile phone 80 or the TV 34, whether to follow the advice thus displayed. Information of whether or not the user has determined to follow the advice is transmitted by the mobile phone 80 or the TV 34 to the electric power management advising device 1. Alternatively, it is possible to employ a configuration in which (i) the advice generated is outputted on the electric power management advising device 1 itself and displayed on displaying means (not shown) of the electric power management advising device 1 so as to allow the user to check the advice, and (ii) the user determines (instructs), via inputting means (not shown) of the electric power management advising device 1, whether to follow the advice thus displayed.

On the other hand, the collective control permitting section 116 generates, on the basis of the device state having been supplied, a control command suitable for the device state. When the user determines to follow the advice being displayed, (i) information of the determination of the user is transmitted to the electric power management advising device 1 and (ii) the collective control permitting section 116 supplies, to the collective control executing section 118, the control command having been generated. The collective control executing section 118 supplies the control command to a specific one of the plurality of devices 82, 84, and 86, and the device to which the control command is supplied operates in accordance with the control command. In this manner, it is possible to control a specific one of the plurality of devices 82, 84, and 86 collectively on the basis of advice suitable for a current device state of at least one of the plurality of devices 82, 84, and 86. In so doing, it is possible to (i) control one or more devices collectively on the basis of a device state of a single device or (ii) control one or more devices collectively on the basis of device states of a respective plurality of devices. According to this, advice suitable for a current device state of at least one of the plurality of devices 82, 84, and 86 is provided to the user. Further, in a case where the user follows the advice, a specific device is controlled collectively on the basis of the advice. The user therefore does not have to handle an operation when the user wants to employ the advice provided to the user. This keeps the user free from inconvenience. Therefore, it becomes possible to achieve an electric power saving effect reliably and provide a more comfortable and enriched life to the user.

Note that it is possible to make a comparison, before generating the advice, between (i) the device state obtained by the device state obtaining section 104 and (ii) another device state. Examples of the another device state encompass a predetermined standard level (standard value) (e.g., prescribed temperature). In this case, the device state obtained by the device state obtaining section 104 is supplied to the recording DB 122 so as to be recorded in the recording DB 122. In the recording DB 122, the predetermined standard level (standard value) and the like as well as the device state obtained by the device state obtaining section 104.

The device state comparing section 106 makes a comparison between the device state and the another device state which are recorded in the recording DB 122. A result of the comparison is supplied to the advice generating section 112 and the collective control permitting section 116. In so doing, it is possible to, for example, (i) obtain current device states of a respective plurality of devices out of the devices 82, 84, and 86 and (ii) make a comparison between the device states obtained (e.g., comparison between an outdoor temperature and a room temperature at the moment). Alternatively, it is possible to make a comparison between device states of a single device whose device state changes (shifts) over time.

The advice generating section 112 generates, on the basis of the result of the comparison having been supplied, advice suitable for the result of the comparison. On the other hand, the collective control permitting section 116 generates, on the basis of the result of the comparison having been supplied, a control command suitable for the result of the comparison. Subsequent processes are similar to those of the foregoing example and description of the subsequent processes is therefore omitted. As described above, it is possible to control a specific one of the plurality of devices 82, 84, and 86 collectively on the basis of a result of comparison between (i) a current device state of at least one of the plurality of devices 82, 84, and 86 and (ii) another device state. This makes it possible to provide appropriate advice to the user in consideration of the current device state and the another device state. For example, in a case where the current device state is deviated from the predetermined standard level and electric power is therefore being wasted, advice to make the device state correspond to the standard level can be provided to the user. This reduces waste of electric power and brings about an electric power saving effect.

The description above was given on the assumption that a device whose device state is to be obtained and a device to be controlled collectively are identical. Note that the present embodiment is not necessarily limited to this. For example, the present embodiment can employ a configuration in which (i) a device state of a device that is different from any of the plurality of devices 82, 84, and 86 is obtained and (ii) advice suitable for the device state is generated. A specific one of the plurality of devices 82, 84, and 86 can be controlled collectively on the basis of the generated advice.

Next, the following description will discuss an example of how the electric power management system 90 operates in a case where advice is generated on the basis of electric power consumption. The electric power consumption measuring section 108 measures electric power consumptions in the respective plurality of devices 82, 84, and 86 at the moment. The electric power consumptions thus measured by the electric power consumption measuring section 108 are supplied to the recording DB 122 so as to be recorded in the recording DB 122. In the recording DB 122, a history of electric power consumptions measured by the electric power consumption measuring section 108 in the past, as well as the electric power consumptions currently measured by the electric power consumption measuring section 108, is recorded.

The electric power consumption comparing section 110 makes a comparison between (i) the electric power consumptions at the moment recorded in the recording DB 122 and (ii) the history of electric power consumptions in the past recorded in the recording DB 122. A result of the comparison is supplied to the advice generating section 112 and the collective control permitting section 116. In so doing, it is possible to employ, for example, a configuration in which (i) changes in electric power consumption over time are measured and (ii), in a case where a result of comparison between (a) electric power consumption at the moment and (b) a history of electric power consumption in the past equals a specific result of comparison a predetermined number of times in a row, the result of comparison is supplied to the advice generating section 112 and the collective control permitting section 116.

The advice generating section 112 generates, on the basis of the result of the comparison supplied to the advice generating section 112, advice suitable for the result of the comparison. The collective control permitting section 116 generates, on the basis of the result of the comparison supplied to the collective control permitting section 116, a control command suitable for the result of the comparison. Subsequent processes are similar to those of the foregoing example and description of the subsequent processes is therefore omitted. As described above, it is possible to control a specific one of the plurality of devices 82, 84, and 86 collectively on the basis of advise suitable for a result of comparison between electric power consumptions in the respective plurality of devices 82, 84, and 86 at the moment and a history of electric power consumptions in the respective plurality of devices 82, 84, and 86 in the past. For example, in a case where electric power consumption at the moment exceeds electric power consumption in the past, the user is warned of a possible waste in electric power consumption and is provided with countermeasures against the wasteful electric power consumption. The user is therefore informed of anything unusual in a case where, for example, electric power consumption that is excessive as compared with the past is observed. This makes it possible to prevent wasteful electric power consumption.

Next, the following description will discuss an example of how the electric power management system 90 operates in a case where advice is generated on the basis of an amount of electric power generated by the photovoltaic power generation device 12. The generated electric power measuring section 100 measures, by means of the power conditioner 14, an amount of electric power generated at the moment. The amount of electric power generated thus measured by the generated electric power measuring section 100 is supplied to the advice generating section 112 and the collective control permitting section 116.

The advice generating section 112 generates, on the basis of the amount of electric power generated thus supplied to the advice generating section 112, advice suitable for the amount of electric power generated. The collective control permitting section 116 generates, on the basis of the amount of electric power generated thus supplied to the collective control permitting section 116, a control command suitable for the amount of electric power generated. Subsequent processes are similar to those of the foregoing example and description of the subsequent processes is therefore omitted. As described above, it is possible to control a specific one of the plurality of devices 82, 84, and 86 collectively on the basis of advice suitable for an amount of electric power generated by the photovoltaic power generation device 12.

Note that it is possible to make a comparison, before generating the advice, between (i) the amount of electric power generated that is measured by the generated electric power measuring section 100 and (ii) an amount of electric power consumed in the house 2. In this case, the amount of electric power generated that is measured by the generated electric power measuring section 100 is supplied to the recording DB 122 so as to be recorded in the recording DB 122. In the recording DB 122, the amount of electric power consumed in the house 2 and the like are recorded, as well as the amount of electric power generated that is measured by the generated electric power measuring section 100.

The generated electric power comparing section 102 makes a comparison between (i) the amount of electric power generated at the moment that is recorded in the recording DB 122 and (ii) the amount of electric power consumed in the house 2. A result of the comparison is supplied to the advice generating section 112 and the collective control permitting section 116.

The advice generating section 112 generates, on the basis of the result of the comparison supplied to the advice generating section 112, advice suitable for the result of the comparison. The collective control permitting section 116 generates, on the basis of the result of the comparison supplied to the collective control permitting section 116, a control command suitable for the result of the comparison. Subsequent processes are similar to those of the foregoing example and description of the subsequent processes is therefore omitted. As described above, it is possible to control a specific one of the plurality of devices 82, 84, and 86 collectively on the basis of advice suitable for a result of comparison between (i) an amount of electric power generated by the photovoltaic power generation device 12 and (ii) an amount of electric power consumed in the house 2. This makes it possible to provide appropriate advice to the user in consideration of the amount of electric power generated and the amount of electric power consumed. For example, in a case where the amount of electric power generated is smaller than the amount of electric power consumed, advice to reduce the electric power consumption as much as possible can be provided to the user. This brings about an electric power saving effect.

(Generation of Advice)

In the electric power management advising device, information supplied to the advice generating section 112 is equivalent to a trigger for generation of advice. The trigger and advice corresponding to the trigger are stored in advance in a memory (not shown) in the electric power management advising device such that the trigger and the advice are associated with each other. That is, for each expected trigger, a corresponding advice is prepared in advance. Therefore, “to generate advice” denotes obtaining advice corresponding to inputted information (trigger) by searching the memory for the advice.

(Generation of Control Command)

In the electric power management advising device, information supplied to the collective control permitting section 116 is a trigger for generation of a control command. The trigger and a control command corresponding to the trigger are stored in advance in a memory (not shown) in the electric power management advising device such that the trigger and the control command are associated with each other. That is, for each expected trigger, a corresponding control command is prepared in advance. Therefore, “to generate a control command” denotes obtaining a control command corresponding to inputted information (trigger) by searching the memory for the control command.

(Power-Saving Control in Heating Mode)

The following description will discuss an example in which an air conditioner and a window are collectively controlled. The example is described on the assumption that the present season is winter and the air conditioner 28 is caused to operate in a heating mode.

The generated electric power measuring section 100 measures, by means of the power conditioner 14, an amount of electric power generated at the moment and supplies the amount to the generated electric power comparing section 102. The generated electric power comparing section 102 makes a comparison between (i) the amount of electric power generated that has been measured and (ii) an amount of electric power consumed in the house 2. In this example, the result of comparison is that the amount of electric power generated is smaller than the amount of electric power consumed. The result of comparison is therefore supplied to the advice generating section 112 and the collective control permitting section 116.

The device state obtaining section 104 obtains, from the air conditioner 28 in the living room 6, a set value of temperature. The device state comparing section 106 makes a comparison between the set value obtained and a prescribed value (18° C.). In the present example, the result of comparison is that the set value is higher than the prescribed value. The device state comparing section 106 therefore supplies the result of comparison to the advice generating section 112 and the collective control permitting section 116.

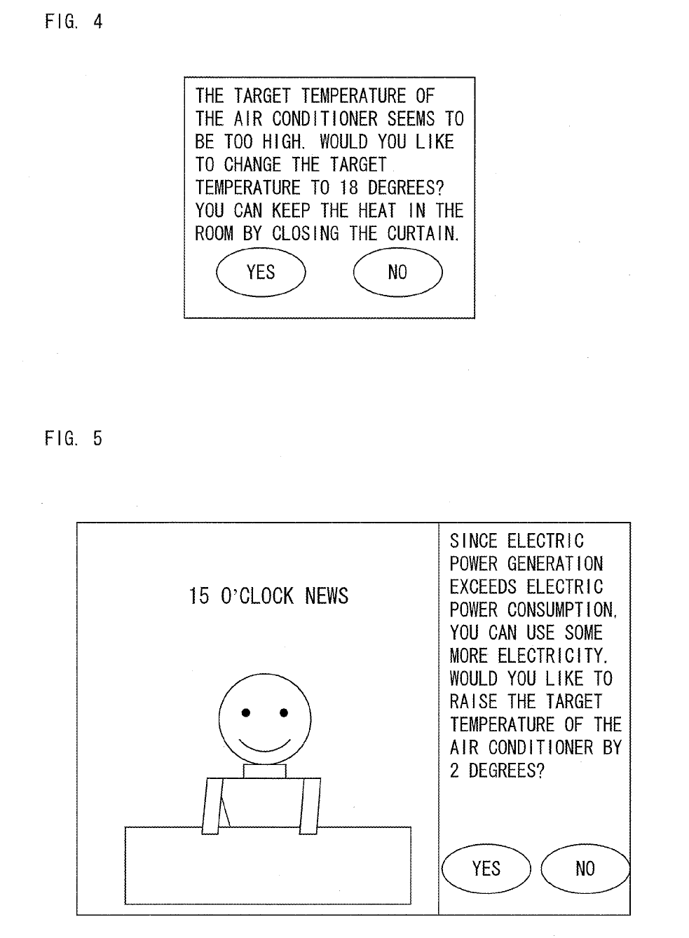

The advice generating section 112 generates, on the basis of the information supplied to the advice generating section 112, advice “The target temperature of the air conditioner seems to be too high. Would you like to change the set value to 18° C.? You can keep the heat in the room by closing the curtain.” The advice outputting section 114 supplies the advice to the TV 34. As a result, the advice is displayed on a screen of the TV 34. An example of such display is shown in FIG. 4. FIG. 4 is a view illustrating an example of how advice is displayed in a case where the advice is displayed on the TV 34. As illustrated in FIG. 4, the advice having been generated is displayed on the screen of the TV 34. At this time, two options (a) YES and (b) NO for whether to follow the advice being displayed are displayed. By entering “YES” and “NO,” the user can determine whether or not to follow the advice being displayed. The description above discussed a configuration in which generated advice is displayed on the TV 34, but the present embodiment is not necessarily limited to this. For example, the generated advice can be displayed on the mobile phone 80 or on the electric power monitor 18.

The collective control permitting section 116 generates, on the basis of the information supplied to the collective control permitting section 116, (i) a control command A for setting a set value of temperature of an air conditioner to the prescribed value (18° C.) and (ii) a control command B for closing a curtain of a room. When the user enters “YES” for the advice being displayed on the screen of the TV 34, the collective control permitting section 116 supplies the control commands A and B, which have been generated, to the collective control executing section 118. The collective control executing section 118 supplies the control command A to the air conditioner 28 and supplies the control command B to the curtain 26 of the living room 6, in which the air conditioner 28 is provided.

Carrying out these processes causes the set value of temperature of the air conditioner 28 during the heating mode to the prescribed value (18° C.) and causes the curtain 26 to automatically close. Accordingly, the temperature in the living room 6 becomes less apt to decrease and an amount of electric power consumed by the air conditioner 28 decreases. This brings about an electric power saving effect.

Note that the control command A can be supplied to all of the air conditioners 28, 48, and 66 operating in the house 2, and the control command B can be supplied to all of the curtains 26, 44, and 64 in the respective rooms. This causes all of the set values of temperature of the respective air conditioners 28, 48, and 66 to be set to 18° C. and causes all of the curtains 26, 44, and 64 to close. Consequently, the electric power saving effect is enhanced.

(Power-Saving Control in Cooling Mode)

The following description will discuss another example in which an air conditioner and a curtain are collectively controlled. The example is discussed on the assumption that the present season is summer and the air conditioner 28 is caused to operate in a cooling mode.

The generated electric power measuring section 100 measures, by means of the power conditioner 14, an amount of electric power generated at the moment and supplies the amount to the generated electric power comparing section 102. The generated electric power comparing section 102 makes a comparison between the amount of electric power generated that has been measured and an amount of electric power consumed in the house 2. In this example, the result of comparison is that the amount of electric power generated is smaller than the amount of electric power consumed. The generated electric power comparing section 102 therefore supplies the result of comparison to the advice generating section 112 and the collective control permitting section 116.

The device state obtaining section 104 obtains, from the air conditioner 28 in the living room 6, a set value of temperature. The device state comparing section 106 makes a comparison between the set value obtained and a prescribed value (28° C.). In the present example, the result of comparison is that the set value is lower than the prescribed value. The device state comparing section 106 therefore supplies the result of comparison to the advice generating section 112 and the collective control permitting section 116.

The advice generating section 112 generates, on the basis of the information supplied to the advice generating section 112, advice “The target temperature of the air conditioner seems to be too low. Would you like to change the set value to 28° C.? You can shut off heat outside by closing the curtain.” The advice outputting section 114 supplies the advice to the TV 34. This causes the advice to be displayed on the screen of the TV 34.

The collective control permitting section 116 generates, on the basis of the information supplied to the collective control permitting section 116, (i) a control command A for setting a set value of temperature of an air conditioner to the prescribed value (28° C.) and (ii) a control command B for closing a curtain of a room. When the user enters “YES” for the advice displayed on the screen of the TV 34, the collective control permitting section 116 supplies the control commands A and B, which have been generated, to the collective control executing section 118. The collective control executing section 118 supplies the control command A to the air conditioner 28 and supplies the control command B to the curtain 26 of the living room 6, in which the air conditioner 28 is provided.

Carrying out these processes causes the set value of temperature of the air conditioner 28 during the cooling mode to the prescribed value (28° C.) and causes the curtain 26 to automatically close. Accordingly, the temperature in the living room 6 becomes less apt to increase and an amount of electric power consumed by the air conditioner 28 decreases. This brings about an electric power saving effect.

Note that the control command A can be supplied to all of the air conditioners 28, 48, and 66 operating in the house 2, and the control command B can be supplied to all of the curtains 26, 44, and 64 in the respective rooms. This causes all of the set values of temperature of the respective air conditioners 28, 48, and 66 to be set to 28° C. and causes all of the curtains 26, 44, and 64 to close. Consequently, the electric power saving effect is enhanced.

(Collective Control a Plurality of Air Conditioners in Heating Mode)

The following description will discuss an example in which a plurality of air conditioners are collectively controlled. Note that the example is discussed on the assumption that the present season is winter and the air conditioner 28 is caused to operate in a heating mode.

The generated electric power measuring section 100 measures, by means of the power conditioner 14, an amount of electric power generated at the moment and supplies the amount to the generated electric power comparing section 102. The generated electric power comparing section 102 makes a comparison between (i) the amount of electric power generated that has been measured and (ii) an amount of electric power consumed in the house 2. In this example, the result of comparison is that the amount of electric power generated is larger than the amount of electric power consumed. The generated electric power comparing section 102 therefore supplies the result of comparison to the advice generating section 112 and the collective control permitting section 116.

The device state obtaining section 104 obtains, from the threes air conditioners 28, 48, and 66, set values of temperature of the respective three air conditioners 28, 48, and 66. The device state comparing section 106 makes a comparison between (i) the set values obtained and (ii) a prescribed value (18° C.). In the present example, the result of comparison is that one of the set values is smaller than the prescribed value. The device state comparing section 106 therefore supplies the result of comparison to the advice generating section 112 and the collective control permitting section 116.

The advice generating section 112 generates, on the basis of the information supplied to the advice generating section 112, advice “Since electric power generation exceeds electric power consumption, you can use some more electricity. Would you like to raise the target temperature of the air conditioner by 2° C.?”. The advice outputting section 114 supplies the advice to the TV 34. This causes the advice to be displayed on the screen of the TV 34. An example of such display is shown in FIG. 5. FIG. 5 is a view showing an example of how advice is displayed in a case where the advice is displayed on the TV 34. FIG. 4 showed an example in which the advice is displayed on the entire screen of the TV 34. By contrast, it is possible to display the advice on a part of the screen of the TV 34 as shown in FIG. 5. According to this, even if advice is displayed while the user is watching a program, the advice does not disturb the user's watching of the program. By entering “YES” or “NO” while watching the program, the user can determine whether or not to follow the advice being displayed.

The collective control permitting section 116 generates, on the basis of the information supplied to the collective control permitting section 116, a control command for setting a set value of temperature of an air conditioner to a temperature two degrees higher than a set value that is currently set. When the user enters “YES” for the advice displayed on the screen of the TV 34, the collective control permitting section 116 supplies, to the collective control executing section 118, the control command thus generated. The collective control executing section 118 supplies the control command to the air conditioners 28, 48, and 66.

Carrying out these processes causes a set value of temperature of each of the air conditioners 28, 48, and 66 in the heating mode to be raised by two degrees. This increases the electric power consumptions in the respective air conditioners 28, 48, and 66. However, since the amount of electric power generated is larger than the amount of electric power consumed, it is possible to raise the temperatures in the respective rooms without causing the user to pay an increased electricity bill.

(Collective Control of a Plurality of Air Conditioners in Cooling Mode)

The following description will discuss another example in which a plurality of air conditioners are collectively controlled. The example is discussed on the assumption that the present season is summer and the air conditioner 28 is caused to operate in a cooling mode.

The generated electric power measuring section 100 measures, by means of the power conditioner 14, an amount of electric power generated at the moment and supplies the amount to the generated electric power comparing section 102. The generated electric power comparing section 102 makes a comparison between (i) the amount of electric power generated having been measured and (ii) an amount of electric power consumed in the house 2. In this example, the result of comparison is that the amount of electric power generated is larger than the amount of electric power consumed. The generated electric power comparing section 102 therefore supplies the result of comparison to the advice generating section 112 and the collective control permitting section 116.

The device state obtaining section 104 obtains, from the three air conditioners 28, 48, and 66, set values of temperature of the respective air conditioners 28, 48, and 66. The device state comparing section 106 makes a comparison between the set values thus obtained and a prescribed value (28° C.). In the present example, the result of comparison is that one of the set values is smaller than the prescribed value. The device state comparing section 106 therefore supplies the result of comparison to the advice generating section 112 and the collective control permitting section 116.

The advice generating section 112 generates, on the basis of the information supplied to the advice generating section 112, advice “Since electric power generation exceeds electric power consumption, you can use some more electricity. Would you like to lower the target temperature of the air conditioner by 2° C.?”. The advice outputting section 114 supplies the advice to the TV 34. This causes the advice to be displayed on the screen of the TV 34.

The collective control permitting section 116 generates, on the basis of the information supplied to the collective control permitting section 116, a control command for setting a set value of temperature of an air conditioner to a temperature two degree lower than a set value that is currently set. When the user enters “YES” for the advice displayed on the screen of the TV 34, the collective control permitting section 116 supplies the control command thus generated to the collective control executing section 118. The collective control executing section 118 supplies the control command to the air conditioners 28, 48, and 66.

Carrying out these processes causes a set value of temperature of each of the air conditioners 28, 48, and 66 to be lowered by two degrees. This increases the of electric power consumptions in the respective air conditioners 28, 48, and 66. However, since the amount of electric power generated is larger than the amount of electric power consumed, it is possible to lower the temperatures in the respective rooms without causing the user to pay an increased electricity bill.

(Power-Saving Control in Heating Mode)

The following description will discuss an example in which an air conditioner and a window are collectively controlled. The example is discussed on the assumption that the present season is winter and the air conditioner 28 is caused to operate in a heating mode. The air conditioner 28 includes a sensor for measuring a temperature outside the house 2 and a sensor for measuring a temperature in the living room 6.

The device state obtaining section 104 obtains, from the air conditioner 28 in the living room 6, a mode of driving of the air conditioner 28. In the present example, the device state obtaining section 104 obtains “heating mode” and supplies it to the advice generating section 112 and the collective control permitting section 116.

The device state obtaining section 104 further obtains, from the air conditioner 28, a temperature outside the house 2 and a temperature in the living room 6. The device state comparing section 106 makes a comparison between an outdoor temperature and a room temperature, which have been thus obtained. In the present example, the result of comparison is that the outdoor temperature is higher than the room temperature. The device state comparing section 106 therefore supplies the result of comparison to the advice generating section 112 and the collective control permitting section 116.

The advice generating section 112 generates, on the basis of the information supplied to the advice generating section 112, advice “It's warmer outside. Would you like to turn off the air conditioner and open the window?”. The advice outputting section 114 supplies the advice to the TV 34. This causes the advice to be displayed on the screen of the TV 34.

The collective control permitting section 116 generates, on the basis of the information supplied to the collective control permitting section 116, a control command A for turning off an air conditioner and a control command B for opening a window of a room. When the user enters “YES” for the advice displayed on the screen of the TV 34, the collective control permitting section 116 supplies the control commands A and B, which have been generated, to the collective control executing section 118. The collective control executing section 118 supplies the control command A to the air conditioner 28 and supplies the control command B to the window 24 of the living room 6, in which the air conditioner 28 is provided.

Carrying out these processes causes the air conditioner 28 to be turned off and causes the window 24 to open automatically. Accordingly, the temperature in the living room 6 increases and an amount of electric power consumed by the air conditioner 28 decreases. This brings about an electric power saving effect.

(Power-Saving Control in Cooling Mode)

The following description will discuss an example in which an air conditioner and a curtain are collectively controlled. The example is discussed on the assumption that the present season is summer and the air conditioner 28 is caused to operate in a cooling mode. The air conditioner 28 includes a sensor for measuring a temperature outside the house 2 and a sensor for measuring a temperature in the living room 6.

The device state obtaining section 104 obtains, from the air conditioner 28 in the living room 6, a mode of driving of the air conditioner 28. In the present example, the device state obtaining section 104 obtains “cooling mode” and supplies it to the advice generating section 112 and the collective control permitting section 116.

The device state obtaining section 104 further obtains, from the air conditioner 28, a temperature outside the house 2 and a temperature in the living room 6. The device state comparing section 106 makes a comparison between an outdoor temperature and a room temperature, which have been thus obtained. In the present example, the result of comparison is that the outdoor temperature is lower than the room temperature. The device state comparing section 106 therefore supplies the result of comparison to the advice generating section 112 and the collective control permitting section 116.

The advice generating section 112 generates, on the basis of the information supplied to the advice generating section 112, advice “It's cooler outside. Would you like to turn off the air conditioner and open the window?”. The advice outputting section 114 supplies the advice to the TV 34. This causes the advice to be displayed on the screen of the TV 34.

The collective control permitting section 116 generates, on the basis of the information supplied to the collective control permitting section 116, a control command A for turning off an air conditioner and a control command B for opening a window of a room. When the user enters “YES” for the advice displayed on the screen of the TV 34, the collective control permitting section 116 supplies the control commands A and B, which have been generated, to the collective control executing section 118. The collective control executing section 118 supplies the control command A to the air conditioner 28 and supplies the control command B to the window 24 of the living room 6, in which the air conditioner 28 is provided.

Carrying out these processes causes the air conditioner 28 to be turned off and causes the window 24 to open automatically. Accordingly, the temperature in the living room 6 decreases and an amount of electric power consumed by the air conditioner 28 decreases. This brings about an electric power saving effect.

(Power-Saving Control During the User's Absence)

The following description will discuss an example in which a plurality of devices are collectively controlled in a case where the user is not in the house 2. The example is discussed on the assumption that a human sensor is installed at the entrance and, when the human sensor detects a person, the electric light at the entrance switches on automatically. The living room 6 is equipped with a home security alarm system, which has a function of notifying the user (resident) by e-mail or the like in a case where a window opens etc. while the user is not in the house.

The device state obtaining section 104 obtains a state of the electric light at the entrance and a state of the door of the entrance, and supplies the states to the device state comparing section 106. The device state comparing section 106 determines (i) transition of the state of the electric light at the entrance and (ii) transition of the state of the door of the entrance so as to determine whether or not “the electric light at the entrance automatically switched on, then the door of the entrance was unlocked, and subsequently the door was opened and then locked.” In the present example, the result of the determination is “true,” and the result is supplied to the advice generating section 112 and the collective control permitting section 116.

The device state obtaining section 104 obtains, from the air conditioner 28 in the living room 6, a state of operation of the air conditioner 28. The device state obtaining section 104 further obtains, from each of the electric lights 30 and 32 in the living room 6, a state of operation of the each of the electric lights 30 and 32. In the present example, the device state obtaining section 104 obtains “on-state.” The device state obtaining section 104 supplies, to the advice generating section 112 and the collective control permitting section 116, all of the states which have been obtained.

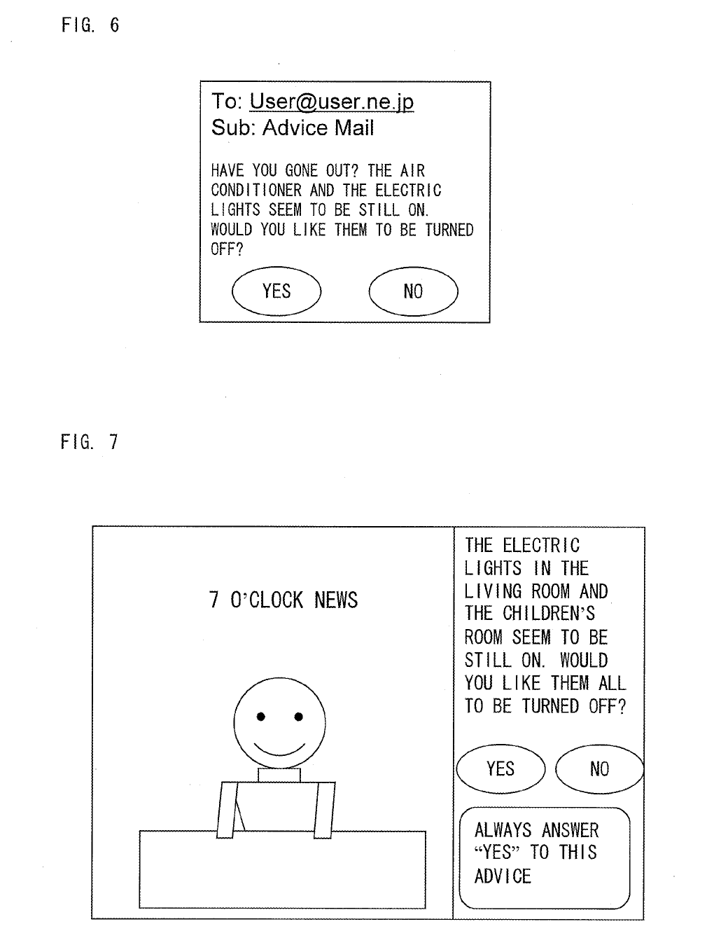

The advice generating section 112 generates, on the basis of the information supplied to the advice generating section 112, advice “Have you gone out? The air conditioner and the electric lights seem to be still on. Would you like them to be turned off?”. The advice outputting section 114 transmits the advice to the mobile phone 80. This causes the advice to be displayed on the mobile phone 80. An example of such display is shown in FIG. 6. FIG. 6 is a view showing an example of how advice is displayed in a case where the advice is displayed on the mobile phone 80. Examples of a technique of displaying the advice on the mobile phone 80 encompass transmitting, to the mobile phone 80 of the user, an e-mail containing the advice. In this case, the advice is displayed in the message of the e-mail as shown in FIG. 6. At this time, the e-mail can, for example, have a title (in FIG. 6, “Advice Mail”) that allows the user to know immediately that the user has received an e-mail containing advice. In the message of the e-mail, two options (a) YES and (b) NO for whether or not to follow the displayed advice are displayed. It is possible to employ a configuration in which the user enters “YES” or “NO,” so that the information is transmitted to the electric power management advising device 1. Specifically, it is possible to employ a configuration in which, for example, (i) a URL corresponding to “YES” and a URL corresponding to “NO” are displayed in the e-mail, and (ii) the user accesses one of the URLs via the mobile phone 80, so that the electric power management advising device 1 is notified of which of “YES” and “NO” was selected by the user. According to this, even in a case where the user is not in the house, the user can determine, via the mobile phone 80, whether or not to follow the advice displayed on the mobile phone 80.

The collective control permitting section 116 generates, on the basis of the information supplied to the collective control permitting section 116, a control command A for turning off an air conditioner, a control command B for turning off an electric light, and a control command C for turning on a home security alarm system. When the user enters “YES” to the advice displayed on the screen of the mobile phone 80, the collective control permitting section 116 supplies the control commands A, B, and C, which have been generated, to the collective control executing section 118. The collective control executing section 118 supplies the control command A to the air conditioner 28, supplies the control command B to the electric lights 30 and 32, and supplies the control command C to the home security alarm system. Specifically, the devices as described above can be controlled by means of, for example, ECHONET, DLNA (Digital Living Network Alliance), or the like.

Carrying out these processes (i) causes the air conditioner 28 and the electric lights 30 and 32 to be turned off and (ii) causes the home security alarm system to turn on, after the user has left the house. This makes it possible to achieve an electric power saving effect and to enhance the level of security of the house 2 automatically.

(Power-Saving Control Carried Out when the User Returns to House)

The following description will discuss an example in which a plurality of devices are collectively controlled in a case where the user returns to the house 2. The example is discussed on the assumption that (i) a human sensor is installed at the entrance and (ii) an electric light at the entrance automatically switches on when the human sensor detects a person. The living room 6 is equipped with a home security alarm system, which has a function of notifying the user by e-mail in a case where a window opens etc. while the user is not in the house.

The device state obtaining section 104 obtains a state of the electric light at the entrance and a state of the door of the entrance, and supplies the states to the device state comparing section 106. The device state comparing section 106 determines (i) transition of the state of the electric light at the entrance and (ii) transition of the state of the door of the entrance so as to determine whether or not “the door of the entrance was unlocked, then the door was opened and subsequently the electric light at the entrance automatically switched on.” In the present example, the result of the determination is “true,” and the result is supplied to the advice generating section 112 and the collective control permitting section 116.

The advice generating section 112 generates, on the basis of the information supplied to the advice generating section 112, advice “Welcome back home. Would you like to turn on the air conditioners and the electric lights?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, a control command A for turning on an air conditioner, a control command B for turning on an electric light, and a control command C for turning off a home security alarm system. When the user enters “YES” to the advice displayed on the screen of the mobile phone 80, the collective control permitting section 116 supplies the control commands A, B, and C, which have been generated, to the collective control executing section 118. The collective control executing section 118 supplies the control command A to the air conditioner 28, supplies the control command B to the electric lights 30 and 32, and the control command C to the home security alarm system.

These processes (i) causes the air conditioner 28 and the electric lights 30 and 32 to be turned on and (ii) causes the home security alarm system to be turned off, after the user returns to the house. This (i) allows the user to not handle operations after the user returns to the house and (ii) brings about an electric power saving effect.

(Power-Saving Control of Electric Light)

The following description will discuss an example of collective control of a plurality of electric lights.

The electric power consumption measuring section 108 measures electric power consumptions in the respective electric lights 30, 32, 48, and 68. The electric power consumption comparing section 110 makes a comparison between (i) each of the electric power consumptions and (ii) a history of electric power consumption in the past so as to determine whether or not each of the electric power consumptions having been measured exceeded the history for more than 3 hours. In the present example, the result of determination is that the electric power consumptions in the electric lights 30, 32, and 48 exceeded the history for more than 3 hours. The electric power consumption comparing section 110 therefore supplies the result of determination to the advice generating section 112 and the collective control permitting section 116.

The advice generating section 112 generates, on the basis of the information supplied to the advice generating section 112, advice “The electric lights in the living room and the dining and kitchen seem to be still on. Would you like them all to be turned off?”. The advice outputting section 114 supplies the advice to the TV 34. This causes the advice to be displayed on the screen of the TV 34. An example of such display is shown in FIG. 7. FIG. 7 is a view showing an example of how advice is displayed in a case where the advice is displayed on the TV 34. FIGS. 4 and 5 each showed an example in which two options (a) YES and (b) NO were displayed for whether or not to follow advice being displayed. In FIG. 7, it is possible to add, for example, a third option (c) ALWAYS ANSWER “YES” TO THIS ADVICE. If the user enters the option “ALWAYS ANSWER “YES” TO THIS ADVICE,” any of the electric lights 30, 32, 48, and 68 which is in an on-state for more than 3 hours (any of the electric lights 30, 32, 48, and 68 whose electric power consumption exceeds the history in the past for more than 3 hours) after the user enters the option is automatically turned off. According to this, the user does not have to enter “YES” or “NO” every time the electric lights are in a state as described above. This saves the user time and effort.

The collective control permitting section 116 generates, on the basis of the information supplied to the collective control permitting section 116, a control command for turning off an electric light. When the user enters “YES” for the advice displayed on the screen of the TV 34, the collective control permitting section 116 supplies the control command thus generated to the collective control executing section 118. The collective control executing section 118 supplies the control command to the electric lights 30, 32, and 48.

Carrying out these processes causes the electric lights in the living room 6 and the electric light in the dining and kitchen room 8 to switch off automatically. This brings about an electric power saving effect.

In a case where there is no input from the user after the advice is outputted, the advice generating section 112 generates, on the basis of the information supplied to the advice generating section 112, advice “The lights in the living room and the dining room seem to have been left on all night. Would you like them to be all turned off now and, if the same thing happens in the future, would you like them to be turned off automatically?”. The advice outputting section 114 supplies the advice to the TV 34. This causes the advice to be displayed on the screen of the TV 34.

The collective control permitting section 116 generates, on the basis of the information supplied to the collective control permitting section 116, a control command for turning off an electric light. When the user enters “YES” for the advice displayed on the screen of the TV 34, the collective control permitting section 116 supplies the control command thus generated to the collective control executing section 118. The collective control executing section 118 supplies the control command to the electric lights 30, 32, and 48.

Carrying out these processes causes the electric lights in the living room 6 and the electric light in the dining and kitchen room 8 to switch off automatically. This brings about an electric power saving effect. The collective control executing section 118 thereafter supplies, to an electric light whose electric power consumption exceeds the history for more than 3 hours, a control command for causing the electric light to switch off automatically.

(Power-Saving Control Carried Out in a Case where DVD is Inserted)

The following description will discuss an example of how a plurality of devices are collectively controlled in a case where a DVD of a movie is inserted into the DVD player 58.

The device state obtaining section 104 obtains, from the DVD player 58 in the dining and kitchen room 8, a state of insertion of a DVD. In the present example, the device state obtaining section 104 obtains the state of insertion at a point in time when the user has inserted the DVD of the movie, and the device state obtaining section 104 supplies the “state of insertion” thus obtained to the advice generating section 112 and the collective control permitting section 116.

The advice generating section 112 generates, on the basis of the information supplied to the advice generating section 112, advice “A DVD has been inserted. Would you like to watch a movie? Would you like to set the environment for the movie?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, (i) a control command A for turning on the TV 56 and setting the external input of the TV 56 to an input port to which the DVD player is connected, (ii) a control command B for closing a curtain, (iii) a control command C for dimming an electric light, and (iv) a control command D for turning off a device. When the user enters “YES” for the advice displayed on the screen of the mobile phone 80, the collective control permitting section 116 supplies the control commands A, B, C and D thus generated to the collective control executing section 118. The collective control executing section 118 supplies the control command A to the TV 56, supplies the control command B to the curtain 44, supplies the control command C to the electric light 48, and supplies the control command D to a device (DVD device, BD device, game device, and the like), other than the DVD player 58, connected with the TV 56.

Carrying out these processes causes the TV 56 to be turned on so as to start playing the movie recorded on the DVD. In addition, (i) the dining and kitchen room 8 is dimmed and (ii) other devices that are not used while the user watches the movie are caused to switch off automatically. This brings about an electric power saving effect.

It is possible to employ a configuration in which the insertion of the DVD into the DVD player 58 causes the TV 56 to be turned on via HDMI, so that the advice is displayed on the TV 56. In this case, the control command A is for “setting the external input of a TV to an input port to which a DVD player is connected.” The other control commands are the same as described above.

(Power-Saving Control Carried Out in a Case where DVD Player 58 is Turned on)

The following description will discuss an example of how a plurality of devices are collectively controlled in a case where the DVD player 58 is turned on.

The device state obtaining section 104 obtains, from the DVD player 58 in the dining and kitchen room 8, a power state of the DVD player 58. In the present example, the device state obtaining section 104 obtains the power state at a point in time when the user has turned on the DVD player 58, and the device state obtaining section 104 supplies “on-state” thus obtained to the advice generating section 112 and the collective control permitting section 116.

The advice generating section 112 generates, on the basis of the information supplied to the advice generating section 112, advice “The DVD player has been turned on. Would you like to watch a movie? Would you like to set the environment for the movie?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, (i) a control command A for turning on the TV 56 and setting the external input of the TV 56 to an input port to which the DVD player is connected, (ii) a control command B for closing a curtain, (iii) a control command C for dimming an electric light, and (iv) a control command D for turning off a device. When the user enters “YES” for the advice displayed on the screen of the mobile phone 80, the collective control permitting section 116 supplies the control commands A, B, C and D thus generated to the collective control executing section 118. The collective control executing section 118 supplies the control command A to the TV 56, supplies the control command B to the curtain 44, supplies the control command C to the electric light 48, and supplies the control command D to a device (DVD device, BD device, game device, and the like), other than the DVD player 58, connected with the TV 56.

Carrying out these processes causes the TV 56 to be turned on so as to start playing the movie recorded on the DVD. In addition, (i) the dining and kitchen room 8 is dimmed and (ii) other devices that are not used while the user watches the movie are caused to switch off automatically. This brings about an electric power saving effect.

It is possible to employ a configuration in which the turning on of the DVD player 58 causes the TV 56 to be turned on via HDMI, so that the advice is displayed on the TV 56. In this case, the control command A is for “setting the external input of a TV to an input port to which a DVD player is connected.” The other control commands are the same as described above.

(Power-Saving Control Carried Out in a Case where External Input of TV 56 is Changed to DVD)

The following description will discuss an example of how a plurality of devices are collectively controlled in a case where the external input of the TV 56 is set to an input port to which the DVD player 58 is connected.

The device state obtaining section 104 obtains, from the TV 56 in the dining and kitchen room 8, a state of the external input of the TV 56. In the present example, the device state obtaining section 104 obtains the state of the external input at a point in time when the user has set the external input of the TV 56 to the input port to which the DVD player 58 is connected, and the device state obtaining section 104 supplies the “state of the external input” thus obtained to the advice generating section 112 and the collective control permitting section 116.

The advice generating section 112 generates, on the basis of the information supplied to the advice generating section 112, advice “The display of the TV has been changed to a DVD mode. Would you like to watch a movie? Would you like to set the environment for the movie?”. The advice outputting section 114 supplies the advice to the TV 56. This causes the advice to be displayed on the screen of the TV 56.

The collective control permitting section 116 generates, on the basis of the information supplied to the collective control permitting section 116, (i) a control command A for turning on a DVD player, (ii) a control command B for closing a curtain, (iii) a control command C for dimming an electric light, and (iv) a control command D for turning off a device. When the user enters “YES” for the advice displayed on the screen of the TV 56, the collective control permitting section 116 supplies the control commands A, B, C, and D thus generated to the collective control executing section 118. The collective control executing section 118 supplies the control command A to the DVD player 58, supplies the control command B to the curtain 44, supplies the control command C to the electric light 48, and supplies the control command D to a device (DVD device, BD device, game device, and the like), other than the DVD player 58, connected with the TV 56.

Carrying out these processes causes the DVD player 58 to be turned on so as to start playing the movie recorded on the DVD. In addition, (i) the dining and kitchen room 8 are dimmed and (ii) other devices that are not used while the user watches the movie are caused to switch off automatically. This brings about an electric power saving effect.

(Power-Saving Control Carried Out in a Case where External Input of TV 34 is Changed to Game Device)

The following description will discuss an example of how a plurality of devices are collectively controlled in a case where the external input of the TV 34 is set to an input port to which a game device is connected. The example is discussed on the assumption that the present time is in a time zone of around 7 o'clock to 16 o'clock, when it is bright outside. The TV 34 has a brightness sensor for detecting brightness around the TV 34.

The device state obtaining section 104 obtains, from the TV 34 in the living room 6, a state of the external input of the TV 34. In the present example, the device state obtaining section 104 obtains the state of the external input at a point in time when the user has set the external input of the TV 34 to the input port to which the game device is connected, and the device state obtaining section 104 supplies the “state of the external input” thus obtained to the advice generating section 112 and the collective control permitting section 116.

The device state obtaining section 104 further (i) obtains, from the brightness sensor of the TV 34, a state of brightness around the TV 34 and (ii) obtains time data from a clock in the living room 6. The device state obtaining section 104 supplies the “state of brightness” thus obtained to the advice generating section 112 and the collective control permitting section 116. The device state comparing section 106 makes a comparison between the time data having been obtained and a prescribed value (7 o'clock to 16 o'clock). In the present example, the result of the comparison is that the present time is in the time zone of 7 o'clock to 16 o'clock. The device state comparing section 106 therefore supplies the result of the comparison to the advice generating section 112 and the collective control permitting section 116.

The advice generating section 112 generates, on the basis of the information supplied to the advice generating section 112, advice “The display of the TV has been changed to a game device mode. Would you like to play a game? Would you like to set the environment for the game?”. The advice outputting section 114 supplies the advice to the TV 34. This causes the advice to be displayed on the screen of the TV 34.

The collective control permitting section 116 generates, on the basis of the information supplied to the collective control permitting section 116, a control command A for turning on the game device, a control command B for adjusting the brightness of an electric light to a predetermined brightness, a control command C for turning off a device, and a control command D for opening a curtain. When the user enters “YES” for the advice displayed on the screen of the TV 34, the collective control permitting section 116 transmits the control commands A, B, C, and D thus generated to the collective control executing section 118. The collective control executing section 118 supplies the control command A to the game device, supplies the control command B to the electric lights 30 and 32, supplies the control command C to a device (DVD device, BD device, game device, and the like), other than the game device, connected with the TV 34, and supplies the control command D to the curtain 26.

Carrying out these processes causes the game device to be turned on so as to allow the game recorded in game software to be played. In addition, (i) the curtain is cause to open, so that the living room 6 has the predetermined brightness (adequate brightness) and (ii) other devices that are not used while the user plays the game are caused to switch off automatically. This brings about an electric power saving effect.

(Power-Saving Control Carried Out in a Case where DVD of Animation Movie is Inserted)

The following description will discuss an example of how a plurality of devices are collectively controlled in a case where a DVD of an animation movie is inserted into the DVD player 58. The example is discussed on the assumption that the present time is in a time zone of around 7 o'clock to 16 o'clock, when it is bright outside. The TV 56 has a brightness sensor for detecting brightness around the TV 34.

The device state obtaining section 104 obtains, from the DVD player 58 in the dining and kitchen room 8, a state of insertion of the DVD. In the present example, the device state obtaining section 104 obtains the state of insertion of the DVD at a point in time when the user has inserted the DVD of the movie, and the device state obtaining section 104 supplies the “state of insertion” thus obtained to the advice generating section 112 and the collective control permitting section 116.

The device state obtaining section 104 further obtains, from the DVD player 58, information on the type of the video of the inserted DVD. In the present example, the result of determination of the type of the video of the inserted DVD is animation. The “result of determination” is therefore supplied to the advice generating section 112 and the collective control permitting section 116.

The device state obtaining section 104 further (i) obtains, from the brightness sensor of the TV 56, a state of brightness around the TV 56 and (ii) obtains time data from a clock in the dining and kitchen room 8. The device state obtaining section 104 supplies the “state of brightness” thus obtained to the advice generating section 112 and the collective control permitting section 116. The device state comparing section 106 makes a comparison between the time data having been obtained and a prescribed value (7 o'clock to 16 o'clock). In the present example, the result of the comparison is that the present time is in the time zone of 7 o'clock to 16 o'clock. The device state comparing section 106 therefore supplies the result to the advice generating section 112 and the collective control permitting section 116.

The advice generating section 112 generates, on the basis of the information supplied to the advice generating section 112, advice “Are going to watch an animation? Would you like to set the environment for the animation?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, a control command A for turning on the TV 56 and setting the external input of the TV 56 to an input port to which the DVD player is connected, a control command B for adjusting the brightness of an electric light to a predetermined brightness, a control command C for turning off a device, and a control command D for opening a curtain. When the user enters “YES” for the advice displayed on the screen of the mobile phone 80, the collective control permitting section 116 transmits the control commands A, B, C, and D thus generated to the collective control executing section 118. The collective control executing section 118 supplies the control command A to the TV 56, supplies the control command B to the electric light 48, supplies the control command C to a device (DVD device, BD device, game device, and the like), other than the DVD player 58, connected with the TV 56, and supplies the control command D to the curtain 26.

Carrying out these processes causes the TV 56 to be turned on so as to allow the movie recorded in the DVD to be played. In addition, (i) the curtain is caused to open, so that the dining and kitchen room 8 has the predetermined brightness (adequate brightness) and (ii) other devices that are not used while the user watches the movie are caused to switch off automatically. This brings about an electric power saving effect.

It is possible to employ a configuration in which the insertion of the DVD of the animation movie into the DVD player 58 causes the TV 56 to be turned on via HDMI, so that the advice is displayed on the TV 56. In this case, the control command A is for “setting the external input of a TV to an input port to which a DVD player is connected.” The other control commands are the same as described above.

(Example 1 of Power-Saving Control Carried Out in a Case where People Gather in Dining and Kitchen Room 8)

The following description will discuss an example of how an electric light and an air conditioner are collectively controlled in a case where people gather in the dining and kitchen room 8. The example is discussed on the assumption that the present season is summer and the present time is around 18 o'clock to 19 o'clock. The dining and kitchen room 8 has a human sensor for detecting whether or not a person is present in the dining kitchen 8.

The device state obtaining section 104 obtains, from the human sensor of the dining and kitchen room 8, a result of detection of whether or not a person is present in the dining and kitchen room 8. In the present example, the result of detection is that people have gathered in the dining and kitchen room 8. The obtained “result of detection” is therefore supplied to the advice generating section 112 and the collective control permitting section 116.

The device state obtaining section 104 further (i) obtains an on-state of each of the electric lights 30, 32, 48, and 68 and (ii) obtains time data from a clock in the dining and kitchen room 8. The device state obtaining section 104 supplies the “on-state” thus obtained to the advice generating section 112 and the collective control permitting section 116. The device state comparing section 106 makes a comparison between the time data having been obtained and a prescribed value (18 o'clock to 19 o'clock). In the present example, the result of the comparison is that the present time is in a time zone of 18 o'clock to 19 o'clock. The device state comparing section 106 therefore supplies the result to the advice generating section 112 and the collective control permitting section 116.

The device state obtaining section 104 further obtains, from the air conditioner 46 in the dining and kitchen room 8, a temperature in the dining and kitchen room 8. The device state comparing section 106 makes a comparison between the room temperature thus obtained and a prescribed value (28° C.). In the present example, the result of the comparison is that the room temperature is higher than the prescribed value. The device state comparing section 106 therefore supplies the result of comparison to the advice generating section 112 and the collective control permitting section 116.

The advice generating section 112 generates, on the basis of the information supplied to the advice generating section 112, advice “Time for a meal? Would you like to turn off the lights in the rooms other than the dining room and the kitchen and dim the light in the dining room?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, a control command A for adjusting an electric light to a predetermined brightness, a control command B for turning on an air conditioner, a control command C for turning off a device. When the user enters “YES” for the advice displayed on the screen of the mobile phone 80, the collective control permitting section 116 supplies the control commands A, B, and C thus generated to the collective control executing section 118. The collective control executing section 118 supplies the control command A to the electric light 48, supplies the control command B to the air conditioner 46, supplies the control command C to the electric lights 30, 32, and 68 and the air conditioners 28 and 66 in the rooms other than the dining and kitchen room 8.

Carrying out these processes (i) causes the dining and kitchen room 8 to have the predetermined brightness (adequate brightness) and (ii) causes the air conditioner 46 in the dining and kitchen room 8 to operate. In addition, (i) the electric lights 30, 32, and 68 in the rooms other than the dining and kitchen room 8 are turned off and (ii) the air conditioners 28 and 66 in the rooms other than the dining and kitchen room 8 are caused to stop. This brings about an electric power saving effect.

(Example 2 of Power-Saving Control Carried Out in a Case where People Gather in Dining and Kitchen Room 8)

The following description will discuss an example of how an electric light and an air conditioner are collectively controlled in a case where people gather in the dining and kitchen room 8. The example is discussed on the assumption that (i) it is bright outside the house 2, (ii) the present season is winter, and (iii) the present time is around 6 o'clock to 9 o'clock or around 11 o'clock to 14 o'clock. The house 2 has a human sensor for detecting brightness outside the house 2.

The device state obtaining section 104 obtains, from a human sensor in the dining and kitchen room 8, a result of detection of a person in the dining and kitchen room 8. In the present example, the result of detection is that people have gathered in the dining and kitchen room 8. The obtained “result of detection” is therefore supplied to the advice generating section 112 and the collective control permitting section 116.

The device state obtaining section 104 further obtains, from the brightness sensor of the house 2, a state of brightness outside the house 2. In the present example, it is bright outside the house 2. The obtained “brightness state” is therefore supplied to the advice generating section 112 and the collective control permitting section 116.

The device state obtaining section 104 further (i) obtains an on-state of each of the electric lights 30, 32, and 68 and (ii) obtains time data from a clock in the dining and kitchen room 8. The device state obtaining section 104 supplies the “on-state” thus obtained to the advice generating section 112 and the collective control permitting section 116. The device state comparing section 106 makes a comparison between the time data having been obtained and a prescribed value (6 o'clock to 9 o'clock or 11 o'clock to 14 o'clock). In the present example, the result of the comparison is that the present time is in a time zone of 6 o'clock to 9 o'clock or a time zone of 11 o'clock to 14 o'clock. The device state comparing section 106 therefore supplies the result to the advice generating section 112 and the collective control permitting section 116.

The device state obtaining section 104 further obtains, from the air conditioner 46 in the dining and kitchen room 8, a temperature in the dining and kitchen room 8. The device state comparing section 106 makes a comparison between the room temperature thus obtained and a prescribed value (18° C.). In the present example, the result of the comparison is that the room temperature is lower than the prescribed value. The device state comparing section 106 therefore supplies the result of comparison to the advice generating section 112 and the collective control permitting section 116.

The advice generating section 112 generates, on the basis of the information supplied to the advice generating section 112, advice “Time for a meal? Would you like to turn off the lights in the rooms other than the dining room and the kitchen and close the curtain in the dining room?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, a control command A for turning off an electric light, a control command B for opening a curtain, a control command C for turning on an air conditioner, and a control command D for turning off an air conditioner. When the user enters “YES” for the advice displayed on the screen of the mobile phone 80, the collective control permitting section 116 supplies the control commands A, B, C, and D thus generated to the collective control executing section 118. The collective control executing section 118 supplies the control command A to the electric lights 30, 32, and 68, supplies the control command B to the curtain 44, supplies the command C to the air conditioner 46, supplies the control command D to the air conditioners 28 and 66 in the rooms other than the dining and kitchen room 8.

Carrying out these processes (i) causes the curtain in the dining and kitchen room 8 to be opened and (ii) causes the air conditioner 46 in the dining and kitchen room 8 to operate. In addition, (i) the electric lights 30, 32, and 68 in the rooms other than the dining and kitchen room 8 are turned off and (ii) the air conditioners 28 and 66 are caused to stop. This brings about an electric power saving effect.

(Example 3 of Power-Saving Control Carried Out in a Case where People Gather in Dining and Kitchen Room 8)

The following description will discuss an example of how an electric light and an air conditioner are collectively controlled in a case where people gather in the dining and kitchen room 8. The example is discussed on the assumption that (i) it is dark outside the house 2, (ii) the present season is winter, and (iii) the present time is around 6 o'clock to 9 o'clock or around 11 o'clock to 14 o'clock. The house 2 has a human sensor for detecting brightness outside the house 2.

The device state obtaining section 104 obtains, from a human sensor in the dining and kitchen room 8, a result of detection of a person in the dining and kitchen room 8. In the present example, the result of detection is that people have gathered in the dining and kitchen room 8. The obtained “result of detection” is therefore supplied to the advice generating section 112 and the collective control permitting section 116.

The device state obtaining section 104 further obtains, from the brightness sensor of the house 2, a state of brightness outside the house 2. In the present example, it is dark outside the house 2. The obtained “brightness state” is therefore supplied to the advice generating section 112 and the collective control permitting section 116.

The device state obtaining section 104 further (i) obtains an on-state of each of the electric lights 30, 32, 48, and 68 and (ii) obtains time data from a clock in the dining and kitchen room 8. The device state obtaining section 104 supplies the “on-state” thus obtained to the advice generating section 112 and the collective control permitting section 116. The device state comparing section 106 makes a comparison between the time data having been obtained and a prescribed value (6 o'clock to 9 o'clock or 11 o'clock to 14 o'clock). In the present example, the result of the comparison is that the present time is in a time zone of 6 o'clock to 9 o'clock or a time zone of 11 o'clock to 14 o'clock. The device state comparing section 106 therefore supplies the result to the advice generating section 112 and the collective control permitting section 116.

The device state obtaining section 104 further obtains, from the air conditioner 46 in the dining and kitchen room 8, a temperature in the dining and kitchen room 8. The device state comparing section 106 makes a comparison between the room temperature thus obtained and a prescribed value (18° C.). In the present example, the result of the comparison is that the room temperature is lower than the prescribed value. The device state comparing section 106 therefore supplies the result of comparison to the advice generating section 112 and the collective control permitting section 116.

The advice generating section 112 generates, on the basis of the information supplied to the advice generating section 112, advice “Time for a meal? Would you like to turn off the lights in the rooms other than the dining room and the kitchen and turn on the light in the dining room?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, a control command A for adjusting an electric light to a predetermined brightness, a control command B for turning on an air conditioner, and a control command C for turning off a device. When the user enters “YES” for the advice displayed on the screen of the mobile phone 80, the collective control permitting section 116 supplies the control command thus generated to the collective control executing section 118. The collective control executing section 118 supplies the control command A to the electric lights 48 supplies the command B to the air conditioner 46, and supplies the control command C to the electric lights 30, 32, and 68 and the air conditioners 28 and 66 in the rooms other than the dining and kitchen room 8.

Carrying out these processes (i) causes the dining and kitchen room 8 to have the predetermined brightness (adequate brightness) and (ii) causes the air conditioner 46 in the dining and kitchen room 8 to operate. In addition, (i) the electric lights 30, 32, and 68 in the rooms other than the dining and kitchen room 8 are turned off and (ii) the air conditioners 28 and 66 are caused to stop. This brings about an electric power saving effect.

(Example 1 of Power-Saving Control Carried Out in a Case where Room Air is not Clean)

The following description will discuss an example of how air cleaners are collectively controlled in a case where room air is not clean. The example is discussed on the assumption that there is a person in each of the living room 6 and the children's room 10. Each of the living room 6, the dining and kitchen room 8, and the children's room 10 has a human sensor for detecting whether or not a person is in the room and a sound sensor for detecting a sound in the room.

The device state obtaining section 104 (i) obtains, from each of the human sensors in the living room 6, the dining and kitchen room 8, and the children's room 10, a result of detection whether or not a person is in the room and (ii) obtains, from each of the sound sensors in the living room 6, the dining and kitchen room 8, and the children's room 10, a result of detection whether or not a sound is detected in the room. The device state obtaining section 104 supplies, to the advice generating section 112 and the collective control permitting section 116, the obtained “result of detection” whether a person is present in the room. The device state comparing section 106 makes a comparison between (i) the obtained “result of detection” of a sound in the room and (ii) prescribed data (sound of sneezing). In the present example, the result of the comparison is that a sound of sneezing is detected in the children's room 10. The device state comparing section 106 therefore supplies the result of the comparison to the advice generating section 112 and the collective control permitting section 116.

The advice generating section 112 generates, on the basis of the information supplied to the advice generating section 112, advice “The air does not seem to be clean. Would you like to operate air cleaners in rooms somebody is in?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, a control command A for controlling turning on and off of the air cleaner. When the user enters “YES” for the advice displayed on the screen of the mobile phone 80, the collective control permitting section 116 supplies the control command A thus generated to the collective control executing section 118. The collective control executing section 118 supplies the control command A to the air cleaners 40, 54, and 74.

Carrying out these processes causes the air cleaner 40 in the living room 6 and the air cleaner 74 in the children's room 10 to operate. In addition, the air cleaner 54 in the dining and kitchen room 8 in which nobody is present is turned off. This brings about an electric power saving effect.

(Example 2 of Power-Saving Control Carried Out in a Case where Room Air is not Clean)

The following description will discuss an example of how air cleaners are collectively controlled in a case where room air is not clean. The example is discussed on the assumption that there is a person in each of the living room 6 and the children's room 10. Each of the air cleaners 40, 54, and 74 has an air sensor for detecting an amount of pollen or dust around the air sensor.

The device state obtaining section 104 obtains, from each of the human sensors in the living room 6, the dining and kitchen room 8, and the children's room 10, a result of detection whether or not a person is in the room. The device state obtaining section 104 supplies the obtained “result of detection” of a person in the room to the advice generating section 112 and the collective control permitting section 116.

The device state obtaining section 104 further obtains, from each of the air sensors of the air cleaners 40, 54, and 74, a result of detection of an amount of pollen or dust around the each of the air sensors. The device state comparing section 106 makes a comparison between (i) the obtained “result of detection” of the amount of pollen or dust around each of the air sensors and (ii) a prescribed value (predetermined concentration of pollen or predetermined concentration of dust). In the present example, the result of the comparison is that the concentration of dust around each of the air sensors is higher than the prescribed value. The device state comparing section 106 therefore supplies the result of the comparison to the advice generating section 112 and the collective control permitting section 116.

The advice generating section 112 generates, on the basis of the information supplied to the advice generating section 112, advice “The air does not seem to be clean. Would you like to operate air cleaners in rooms somebody is in?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, a control command A for controlling turning on and off of an air cleaner. When the user enters “YES” for the advice displayed on the screen of the mobile phone 80, the collective control permitting section 116 supplies the control command A thus generated to the collective control executing section 118. The collective control executing section 118 supplies the control command A to the air cleaners 40, 54, and 74.

Carrying out these processes causes the air cleaner 40 in the living room 6 and the air cleaner 74 in the children's room 10 to operate. In addition, the air cleaner 54 in the dining and kitchen room 8 in which nobody is present is turned off. This brings about an electric power saving effect.

(Power-Saving Control Carried Out in a Case where Humidities in Rooms are Decreasing)

The following description will discuss an example of how humidifiers are collectively controlled in a case where humidities in rooms are decreasing. The example is discussed on the assumption that there is a person in each of the living room 6 and the children's room 10. Each of the humidifiers 38, 52, and 72 has a humidity sensor for detecting humidity around the sensor.

The device state obtaining section 104 obtains, from each of the human sensors in the living room 6, the dining and kitchen room 8, and the children's room 10, a result of detection whether or not a person is in the room. The device state obtaining section 104 supplies, to the advice generating section 112 and the collective control permitting section 116, the obtained “result of detection” of a person in the room.

The device state obtaining section 104 further obtains, from each of the humidity sensors of the humidifiers 38, 52, and 72, a result of detection of humidity around the each of the humidity sensors. The device state comparing section 106 makes a comparison between (i) the obtained “result of detection” of humidity around each of the humidity sensors and (ii) a prescribed value (predetermined humidity). In the present example, the result of the comparison is that the humidity around each of the humidity sensors is lower than the prescribed value. The device state comparing section 106 therefore supplies the result of the comparison to the advice generating section 112 and the collective control permitting section 116.

The advice generating section 112 generates, on the basis of the information supplied to the advice generating section 112, advice “The air is dry. Would you like to operate humidifiers in rooms somebody is in?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, a control command A for controlling turning on and off of the humidifier. When the user enters “YES” for the advice displayed on the screen of the mobile phone 80, the collective control permitting section 116 supplies the control command A thus generated to the collective control executing section 118. The collective control executing section 118 supplies the control command A to the humidifiers 38, 52, and 72.

Carrying out these processes causes the humidifier 38 in the living room 6 and the humidifier 72 in the children's room 10 to operate. In addition, the humidifier 52 in the dining and kitchen room 8, in which nobody is present, is turned off. This brings about an electric power saving effect.

(Power-Saving Control Carried Out in a Case where Humidity in a Room is Decreasing During Laundry)

The following description will discuss an example of how a washing machine is collectively controlled in a case where humidity in a room is decreasing during laundry. The example is discussed on the assumption that (i) the present stage is a stage that is right after completion of a spinning process of the washing (state of atmosphere before a drying process) and (ii) the present time is night (around 18 o'clock to 6 o'clock).

The device state obtaining section 104 obtains, from the washing machine 70, a process state of the washing machine. In the present example, the device state obtaining section 104 obtains the process state at a point in time when the washing machine has finished the spinning process. The device state obtaining section 104 supplies the process state” thus obtained to the advice generating section 112 and the collective control permitting section 116.

The device state obtaining section 104 further obtains, from the humidity sensor of the humidifier 72, a result of detection of humidity around the humidity sensor. The device state comparing section 106 makes a comparison between (i) the obtained “result of detection” of the humidity around the humidity sensor and (ii) a prescribed value (predetermined humidity). In the present example, the result of the comparison is that the humidity around the humidity sensor is smaller than the prescribed value. The device state comparing section 106 therefore supplies the result of comparison to the advice generating section 112 and the collective control permitting section 116.

The device state obtaining section 104 further obtains time data from a clock in the children's room 10. The device state comparing section 106 makes a comparison between the time data thus obtained and a prescribed value (18 o'clock to 6 o'clock). In the present example, the present time is in a time zone of 18 o'clock to 6 o'clock. The device state comparing section 106 therefore supplies the result of comparison to the advice generating section 112 and the collective control permitting section 116.

The advice generating section 112 generates, on the basis of the information supplied to the advice generating section 112, advice “Since the air is dry, you can probably dry up the washing by simply hanging it in the room. Would you like to cancel the drying course?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, a control command A for controlling turning on and off of a washing machine and a control command B for turning on an electric light. When the user enters “YES” for the advice displayed on the screen of the mobile phone 80, the collective control permitting section 116 supplies the control commands A and B thus generated to the collective control executing section 118. The collective control executing section 118 supplies the control command A to the washing machine 70 and supplies the control command B to an electric light in a room in which the washing is to be dried.

Carrying out these processes allows the drying process of the washing machine 70 to be omitted and causes the washing machine 70 to be turned off. This brings about an electric power saving effect.

(Example 1 of Collective Control Carried Out in a Case Where Humidity in a Room is Increasing During Laundry)

The following description will discuss an example of how a window and a ventilation fan are collectively controlled in a case where humidity in a room during laundry is increasing. The example is discussed on the assumption that the present stage is a drying process of the washing. The children's room 10 has a humidity sensor for detecting humidity outside the house 2.

The device state obtaining section 104 obtains, from the washing machine 70, a process state of the washing machine. In the present example, the device state obtaining section 104 obtains the process state at a point in time when the washing machine starts the drying process. The device state obtaining section 104 supplies the “process state” thus obtained to the advice generating section 112 and the collective control permitting section 116.

The device state obtaining section 104 further obtains, from the humidity sensor of the children's room 10, a result of detection of humidity outside the house 2. The device state comparing section 106 makes a comparison between (i) the obtained “result of detection” of the humidity around the humidity sensor and (ii) a prescribed value (predetermined humidity). In the present example, the result of the comparison is that the humidity outside the house is lower than the prescribed value. The device state comparing section 106 therefore supplies the result of the comparison to the advice generating section 112 and the collective control permitting section 116.

The device state obtaining section 104 further obtains, from the humidifier 72, a result of detection of the humidity around the humidity sensor. The device state comparing section 106 makes a comparison between (i) the obtained “result of detection” around the humidity sensor and (ii) the prescribed value (predetermined humidity). In the present example, the result of the comparison is that the humidity around the humidity sensor is higher than the prescribed value. The device state comparing section 106 therefore supplies the result of comparison to the advice generating section 112 and the collective control permitting section 116.

The advice generating section 112 generates, on the basis of the information supplied to the advice generating section 112, advice “The humidity is rising because of the ‘drying course’ being carried out. Would you like to open the window to let in some air with low humidity?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, a control command A for opening a window and a control command B for turning on a ventilation fan. When the user enters “YES” for the advice displayed on the screen of the mobile phone 80, the collective control permitting section 116 supplies the control commands A and B thus generated to the collective control executing section 118. The collective control executing section 118 supplies the control command A to the window 62 and supplies the control command B to the ventilation fan 78.

Carrying out these processes causes the window 62 to open and causes the ventilation fan 78 to operate. As a result, dry air comes into the children's room 10, so that the humidity in the children's room 10 can be lowered. It is therefore possible to lower the humidity in the children's room 10 without operating the dehumidifier. This brings about an electric power saving effect.

(Example 2 of Collective Control Carried Out in a Case where Humidity in a Room is Increasing During Laundry)

The following description will discuss an example of how a dehumidifier is collectively controlled in a case where humidity in a room during laundry is increasing. The example is discussed on the assumption that the present stage is a drying process of the washing.

The device state obtaining section 104 obtains, from the washing machine 70, a process state of the washing machine 70. In the present example, the device state obtaining section 104 obtains the process state at a point in time when the washing machine starts the drying process. The device state obtaining section 104 supplies the “process state” thus obtained to the advice generating section 112 and the collective control permitting section 116.

The device state obtaining section 104 further obtains, from the humidifier 72, a result of detection of humidity around the humidifier 72. The device state comparing section 106 makes a comparison between (i) the obtained “result of detection” of the humidity around the humidity sensor and (ii) a prescribed value (predetermined humidity). In the present example, the result of the comparison is that the humidity around the humidifier 72 is higher than the prescribed value. The device state comparing section 106 therefore supplies the result of the comparison to the advice generating section 112 and the collective control permitting section 116.

The advice generating section 112 generates, on the basis of the information supplied to the advice generating section 112, advice “The humidity is rising because of the ‘drying course’ being carried out. Would you like to operate the dehumidifier?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, a control command A for turning on a dehumidifier. When the user enters “YES” for the advice displayed on the screen of the mobile phone 80, the collective control permitting section 116 supplies the control command A thus generated to the collective control executing section 118. The collective control executing section 118 supplies the control command A to the dehumidifier 76.

Carrying out these processes causes the dehumidifier 76 to operate. This makes it possible to lower the humidity in the children's room 10.

(Power-Saving Control Carried Out in a Case where Operation Setting of Refrigerator is “Strong”)

The following description will discuss an example of how a refrigerator and an air conditioner are collectively controlled in a case where an operation setting of the refrigerator is “strong.” The example is discussed on the assumption that the present season is summer.

The device state obtaining section 104 obtains, from the refrigerator 50, a state of operation setting of the refrigerator 50. The “state of operation setting” thus obtained is supplied to the advice generating section 112 and the collective control permitting section 116.

The device state obtaining section 104 further obtains, from the air conditioner 46 in the dining and kitchen room 8, a temperature in the dining and kitchen room 8. The device state comparing section 106 makes a comparison between (i) the room temperature thus obtained and (ii) a prescribed value (28° C.). In the present example, the result of the comparison is that the room temperature is higher than the prescribed value. The device state comparing section 106 therefore supplies the result of the comparison to the advice generating section 112 and the collective control permitting section 116.

The advice generating section 112 generates, on the basis of the information supplied to the advice generating section 112, advice “The operation setting of the refrigerator is ‘strong,’ but ‘weak’ should be enough to keep it cool inside the refrigerator. Would you like to lower the temperature of the room and change the operation setting of the refrigerator to ‘weak’?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, a control command A for changing an operation setting of a refrigerator and a control command B for turning on an air conditioner. When the user enters “YES” for the advice displayed on the screen of the mobile phone 80, the collective control permitting section 116 supplies the control commands A and B thus generated to the collective control executing section 118. The collective control executing section 118 supplies the control command A to the refrigerator 50 and supplies the control command B to the air conditioner 46.

Carrying out these processes causes the air conditioner 46 to operate and causes the temperature in the dining and kitchen room 8 to be lowered. It is therefore possible to keep the inside of the refrigerator 50 cool enough even in a state where the operating setting of the refrigerator 50 is “weak.” This brings about an electric power saving effect.

(Example 1 of Power-Saving Control Carried Out in a Case where Temperature in Room in which Refrigerator is Provided is High)

The following description will discuss an example of how a window and a ventilation fan are collectively controlled in a case where a temperature in a room in which a refrigerator is provided is high. The example is discussed on the assumption that a temperature outside the house 2 is lower than a temperature in the dining and kitchen room 8.

The device state obtaining section 104 obtains, from the air conditioner 46, the temperature outside the house 2 and the temperature in the dining and kitchen room 8. The device state comparing section 106 makes a comparison between the outdoor temperature and the room temperature, which have been thus obtained. In the present example, the result of the comparison is that the outdoor temperature is lower than the room temperature. The device state comparing section 106 therefore supplies the result of the comparison to the advice generating section 112 and the collective control permitting section 116.

The advice generating section 112 generates, on the basis of the information supplied to the advice generating section 112, advice “The temperature in the dining and kitchen room is so high that the refrigerator is in a state that increases the electricity bill. Would you like to open the window and turn on the ventilation fan to let in fresh air?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, a control command A for opening a window and a control command B for turning on a ventilation fan. When the user enters “YES” for the advice displayed on the screen of the mobile phone 80, the collective control permitting section 116 supplies the control commands A and B thus generated to the collective control executing section 118. The collective control executing section 118 supplies the control command A to the window 42 and supplies the control command B to the ventilation fan 60.

Carrying out these processes causes the window 42 to be opened and causes the ventilation fan 60 to be operated. This lowers the temperature in the dining and kitchen room 8, so that the inside of the refrigerator 50 can be cooled enough. This brings about an electric power saving effect.

(Example 2 of Power-Saving Control Carried Out in a Case where Temperature in Room in which Refrigerator is Provided is High)

The following description will discuss an example of how a door and an air conditioner are collectively controlled in a case where a temperature in a room in which a refrigerator is provided is high. The example is discussed on the assumption that the present season is summer and a temperature outside the house 2 is higher than a temperature in the dining and kitchen room 8.

The device state obtaining section 104 obtains, from the air conditioner 46, the temperature outside the house 2 and the temperature in the dining and kitchen room 8. The device state comparing section 106 makes a comparison between the outdoor temperature and the room temperature, which have been thus obtained. In the present example, the result of the comparison is that the outdoor temperature is higher than the room temperature. The device state comparing section 106 therefore supplies the result of the comparison to the advice generating section 112 and the collective control permitting section 116. The device state comparing section 106 makes a comparison between the obtained room temperature and a prescribed value (28° C.). In the present example, the result of the comparison is that the room temperature is higher than the prescribed value. The device state comparing section 106 therefore supplies the result of the comparison to the advice generating section 112 and the collective control permitting section 116.

The advice generating section 112 generates, on the basis of the information supplied to the advice generating section 112, advice “The temperature in the dining and kitchen room is so high that the refrigerator is in a state that increases the electricity bill. Would you like to let in some cold air into the dining and kitchen room?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, a control command A for turning on an air conditioner and a control command B for closing a door. When the user enters “YES” for the advice displayed on the screen of the mobile phone 80, the collective control permitting section 116 supplies the control commands A and B thus generated to the collective control executing section 118. The collective control executing section 118 supplies the control command A to the air conditioner 46 and supplies the control command B to the doors 80 and 82.

Carrying out these processes causes the doors 80 and 82 of the dining and kitchen room 8 to be opened and causes the air conditioner 46 to be operated. This lowers the temperature in the dining and kitchen room 8, so that the inside of the refrigerator 50 can be cooled enough. This brings about an electric power saving effect.

(Example 3 of Power-Saving Control Carried Out in a Case where Temperature in Room in which Refrigerator is Provided is High)

The following description will discuss an example of how a door and an air conditioner are collectively controlled in a case where a temperature in a room in which a refrigerator is provided is high. The example is discussed on the assumption that the present season is summer and a temperature outside the house 2 is higher than a temperature in the dining and kitchen room 8 and no air conditioner is provided in the dining and kitchen room 8. The dining and kitchen room 8 has a sensor for measuring a temperature outside the house 2 and a temperature in the dining and kitchen room 8.

The device state obtaining section 104 obtains, from the sensor of the dining and kitchen 8, the temperature outside the house 2 and the temperature in the dining and kitchen room 8. The device state comparing section 106 makes a comparison between the outdoor temperature and the room temperature, which have been thus obtained. In the present example, the result of the comparison is that the outdoor temperature is higher than the room temperature. The device state comparing section 106 therefore supplies the result of the comparison to the advice generating section 112 and the collective control permitting section 116. The device state comparing section 106 makes a comparison between the obtained room temperature and a prescribed value (28° C.). In the present example, the result of the comparison is that the room temperature is higher than the prescribed value. The device state comparing section 106 therefore supplies the result of the comparison to the advice generating section 112 and the collective control permitting section 116.

The advice generating section 112 generates, on the basis of the information supplied to the advice generating section 112, advice “The temperature in the dining and kitchen room is so high that the refrigerator is in a state that increases the electricity bill. Would you like to let in some cold air into the dining and kitchen room?”. The advice outputting section 114 transmits the advice to the mobile phone 80. This causes the advice to be displayed on the screen of the mobile phone 80.

The collective control permitting section 116 generates, on the basis of the information supplied to the collective control permitting section 116, a control command A for turning on an air conditioner and a control command B for controlling opening and closing of a door. When the user enters “YES” for the advice displayed on the screen of the mobile phone 80, the collective control permitting section 116 supplies the control commands A and B thus generated to the collective control executing section 118. The collective control executing section 118 supplies the control command A to the air conditioner 28 and supplies the control command B to the doors 80 and 82.

Carrying out these processes (i) causes the door 80 of the of the dining and kitchen room 8 to be opened, (ii) the door 82 of the dining and kitchen room 8 to be closed, and (iii) causes the air conditioner 28 of the living room 6 to be operated. This lowers the temperature in the dining and kitchen room 8, so that the inside of the refrigerator 50 can be cooled enough. This brings about an electric power saving effect.

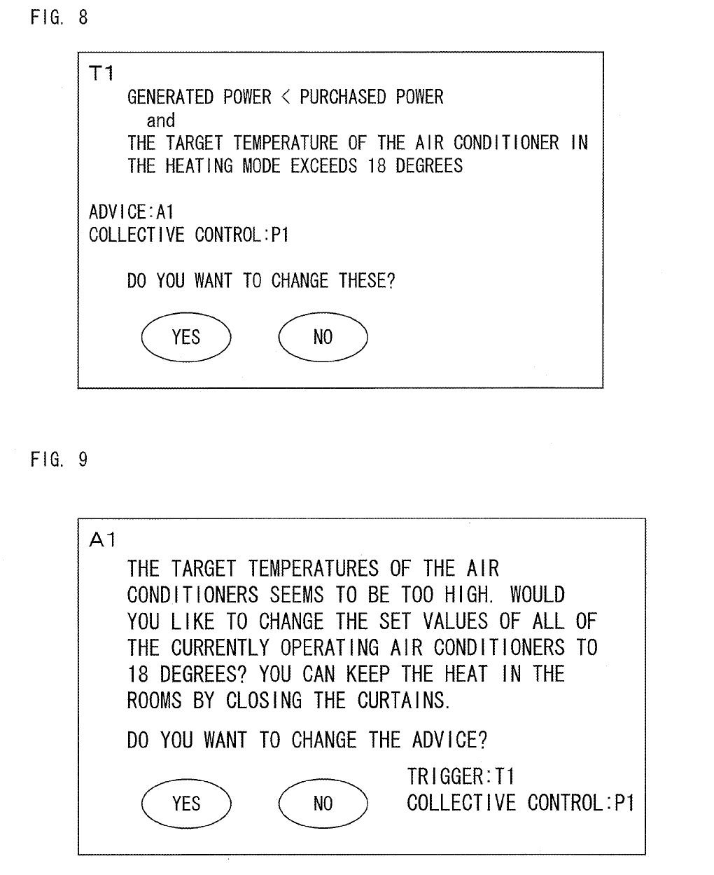

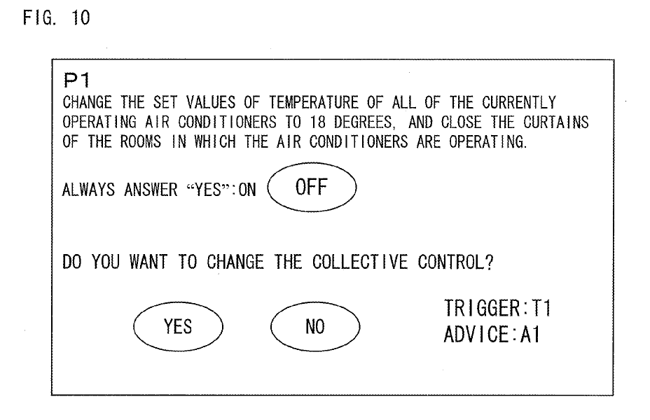

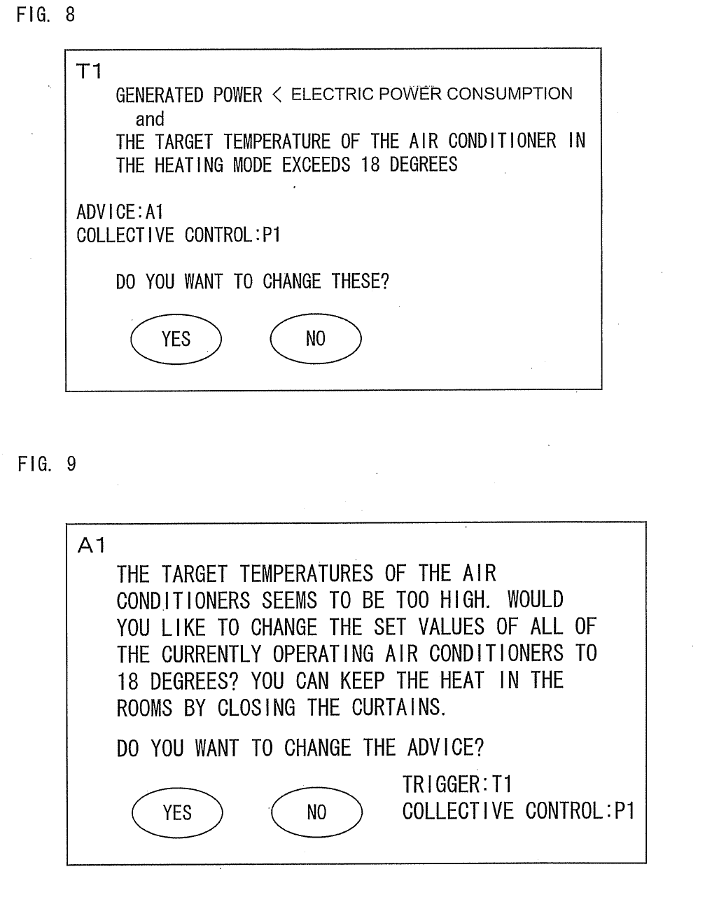

Note that a setting of advice to be displayed to the user, a setting of collective control, and a setting of a trigger can be appropriately changed for customization. For example, the following description will discuss, with reference to FIG. 8, a case in which a condition of a trigger is changed. FIG. 8 is a view showing an example of what is displayed on the screen of the TV 34 in the case of changing the condition of the trigger.

In the case of changing the condition of the trigger, a currently set condition of the trigger (T1), advice (A1) to be displayed corresponding to T1, and a collective control (P1) to be carried out corresponding to T1 are displayed as shown in FIG. 8. In addition, two options (a) YES and (b) NO are displayed with regard to whether to modify the content of T1. By entering either “YES” or “NO,” the user can determine whether to modify the content of T1. In a case where the user enters “YES,” the user can change the specific content of T1 being displayed. For example, the user can change T1 from “The amount of electric power generated is smaller than the electric power consumption, and the target temperature of the air conditioner in the heating mode exceeds 18 degrees” to “The amount of electric power generated is smaller than the electric power consumption, and the target temperature of the air conditioner in the heating mode exceeds 20 degrees.”

Not only the conditions of the trigger but also the setting of the advice (A1) corresponding to T1 and the setting of the collective control (P1) corresponding to T1 can be changed. This will be described below with reference to FIGS. 9 and 10. FIG. 9 is a view illustrating an example of what is displayed on the screen of the TV 34 in a case where sentences of the advice to be displayed are changed. FIG. 10 is a view illustrating an example of what is displayed on the screen of the TV 34 in a case where the content of the collective control is changed.

In the case of changing the sentences of the advice, sentences (A1) of the advice currently set, a condition of the trigger (T1) corresponding to A1, and a collective control (P1) to be carried out corresponding to T1 are displayed, as shown in FIG. 9. By entering either “YES” or “NO,” the user can determine whether to change the content of A1. In a case where the user enters “YES,” the user can change the specific content of A1. For example, the user can change A1 from “The target temperature of the air conditioner seems to be too high. Would you like to change the set value to 18° C.? You can keep the heat in the room by closing the curtain.” to “The target temperatures of the air conditioners seems to be too high. Would you like to change the set values of all of the currently operating air conditioners to 18° C.? You can keep the heat in the rooms by closing the curtains.”

On the other hand, in the case where the content of the collective control is changed, the content of the collective control (P1) currently set, a condition of the trigger (T1) corresponding to P1, and advice (A1) corresponding to P1 are displayed, as shown in FIG. 10. By entering either “YES” or “NO,” the user can determine whether to modify the content of P1. In a case where the user enters “YES,” the user can change the content of P1. For example, the user can change P1 from “Change the set values of temperature of all of the currently operating air conditioners to 18 degrees, and close the curtains of the rooms in which the air conditioners are operating.” to “Change the set values of temperature of all of the currently operating air conditioners to 18 degrees.” At this time, it is possible to set whether to carry out the collective control (P1) automatically in a case where the condition (T1) of the trigger is met. As shown in FIG. 10, two options (a) ON and (b) OFF are displayed with regard to whether to always answer “YES.” By entering either “ON” or “OFF,” the user can determine whether to always carry out the collective control.

(Program and Recording Medium)

Lastly, sections included in the electric power management advising device 1 can be (i) configured as a hardware logic or (ii) realized by means of software by use of a CPU as described below.

That is, the electric power management advising device 1 includes a CPU for executing commands of a program for implementing each function, a RAM on which the program is stored and is loaded so as to be executed, and a storage device (recording medium), such as a memory, in which the program and various data are stored. According to the configuration, the object of the present invention can be achieved by means of a predetermined recording medium.

In the recording medium, program code (an executable program, an intermediate code program, and a source program) of the program (software for implementing the functions) of the electric power management advising device 1 can be recorded so as to be read out by a computer. The recording medium can be supplied to the electric power management advising device 1 so that the electric power management advising device 1 (or a CPU or an MPU) serving as a computer reads out and executes the program code recorded in the supplied recording medium.

The recording medium via which the program code is supplied to the electric power management advising device 1 is not limited to any particular structure or type. That is, for example, a tape such as a magnetic tape or a cassette tape, a disk including (i) a magnetic disk such as a Floppy® disk or a hard disk and (ii) an optical disc such as a CD-ROM, an MO, an MD, a DVD, a BD, or a CD-R, a card such as an IC card (including a memory card) or an optical card, a semiconductor memory such as a mask ROM, an EPROM, an EEPROM, or a flash ROM, or the like can be used as the recording medium.

The object of the present invention can be achieved by arranging the electric power management advising device 1 to be connectable to a communications network so that the program code may be delivered over the communications network. The communications network is not limited to any particular type or in any particular manner as long as the program code can be delivered to the electric power management advising device 1. The communications network may be, for example, the Internet, an intranet, extranet, LAN, ISDN, VAN, CATV communications network, virtual dedicated network (virtual private network), telephone line network, mobile communications network, or satellite communications network.

The transfer medium which makes up the communications network is not limited to any particular arrangement or type provided that the transfer medium is a given medium that can transfer the program code. The transfer medium may be, for example, wired line, such as IEEE 1394, USB, electric power line, cable TV line, telephone line, or ADSL (Asymmetric Digital Subscriber Line) line; or wireless, such as infrared radiation (Ida, remote control), Blue tooth (Registered Trademark), 802.11 wireless, HDR, mobile telephone network, satellite line, or terrestrial digital network. The present invention encompasses a form of a computer data signal embedded into a carrier wave, in which form the program code is realized by electronic transmission.

The present invention is not limited to the above-described embodiments but allows various modifications within the scope of the claims. In other words, any embodiment obtained by combining technical means appropriately modified within the scope of the claims will also be included in the technical scope of the present invention.

For example, although the description above discussed an example in which advice generated by the electric power management advising device 1 is supplied to the mobile phone 80 or the TV 34, the present invention is not necessarily limited to this. For example, it is possible to employ a configuration in which the electric power management advising device 1 includes displaying means such as a display, and advice is displayed on the displaying means so as to allow the user to check the advice. It is also possible to employ a configuration in which the electric power management advising device 1 includes inputting means to which the user can enter instructions, and the user determines (instructs), via the inputting means, whether to follow the advice being displayed.

### OVERVIEW OF EMBODIMENT

As described above, the electric power management device in accordance with the present invention is arranged such that the electric power management device is further connected with another device that is different from any of the plurality of devices, the electric power management device further comprises state obtaining means for obtaining a state of the another device, and the advice generating means generates the advice in accordance with the state obtained by the state obtaining means.

According to the configuration, it is possible to provide the user with advice to which a state of a device other than a device to be collectively controlled is reflected. It is thus not necessary that a device to be collectively controlled and a device whose device state is to be obtained are the same.

In the electric power management device in accordance with the present invention, the advice generating means generates the advice in accordance with a transition of the state obtained by the state obtaining means.

According to the configuration, it is possible to present advice to the user in consideration of a change (transition) over time in a state of a device. The configuration also makes it possible to control a plurality of devices collectively in consideration of such transition.

The electric power management device in accordance with the present invention further includes measured value obtaining means for obtaining, from at least one of the plurality of devices, a measured value which has been measured by means of a sensor included in the at least one of the plurality of devices, the advice generating means generating the advice in accordance with the measured value obtained by the state obtaining means.

According to the configuration, it is possible to present advice to the user in consideration of a value measured by means of a sensor included in at least one of a plurality of devices. This allows controlling a plurality of devices collectively in consideration of such value.

The electric power management device in accordance with the present invention is arranged such that the electric power management device is further connected with another device that is different from any of the plurality of devices, the electric power management device further comprises measured value obtaining means for obtaining a measured value which has been measured by means of a sensor included in the another device, and the advice generating means generates the advice in accordance with the measured value obtained by the measured value obtaining means.

According to the configuration, it is possible to provide the user with advice to which a value measured by means of a sensor included in a device other than a device to be collectively controlled is reflected. A value used to generate advice is thus not necessarily limited to a value measured by means of a sensor included in the device to be collectively controlled.

In the electric power management device in accordance with the present invention, the advice generating means generates the advice in accordance with a transition of the measured value obtained by the measured value obtaining means.

According to the configuration, it is possible to present advice to the user in consideration of a change (transition) over time in a value measured by means of a sensor included in a device. This allows controlling a plurality of devices collectively in consideration of such transition of a value.

The electric power management device in accordance with the present invention further includes: electric power consumption measuring means for measuring electric power consumptions in the respective plurality of devices; and comparing means for making a comparison between (i) each of the electric power consumptions which have been measured by the electric power consumption measuring means and (ii) an electric power consumption in the past, the advice generating means generating the advice in accordance with a result of the comparison by the comparing means.

According to the configuration, it is possible to provide advice in accordance with a result of comparison between (i) electric power consumptions in a respective plurality of devices and (ii) electric power consumptions in the respective plurality of devices in the past. It is also possible to collectively control a specific one of the plurality of devices on the basis of the advice. For example, in a case where electric power consumption at the moment exceeds electric power consumption in the past, the user is warned of a possible waste in electric power consumption and is provided with countermeasures against the wasteful electric power consumption. The user is therefore informed of anything unusual in a case where, for example, electric power consumption that is excessive as compared with the past is observed. This makes it possible to prevent wasteful electric power consumption.

The electric power management device in accordance with the present invention is arranged such that the electric power management device is further connected with a photovoltaic power generation device, the electric power management device further comprises generated electric power measuring means for measuring an amount of electric power generated in the photovoltaic power generation device, and the advice generating means generates the advice in accordance with the amount of electric power generated which has been measured by the generated electric power measuring means.

According to the configuration, it is possible to collectively control a specific one of a plurality of devices on the basis of advice generated in accordance with the amount of electric power generated by the photovoltaic power generation device. It is thus possible to present appropriate advice to the user in consideration of the amount of electric power generated by the photovoltaic power generation device.

In the electric power management device in accordance with the present invention, the advice outputting means transmits the advice to a portable device carried by a user.

According to the configuration, it is possible to display, on a mobile phone carried by the user, advice generated by the electric power management device. This allows the advice generated by the electric power management device to be displayed on the mobile phone while the user is moving around the house or away from the house, so that the user can check the content of the advice provided to the user.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

An electric power management advising device in accordance with the present invention can be applied to, for example, a device or a system which is provided in a house or a building such as an office building and provides advice related to electric power saving.

### REFERENCE SIGNS LIST

1: electric power management advising device
2: house
4: corridor
6: living room
8: dining and kitchen room
10: children's room
12: photovoltaic power generation device
14: power conditioner
34: TV
80: mobile phone
82, 84, and 86: device
90: electric power management system
100: generated electric power measuring section
102: generated electric power comparing section
104: device state obtaining section
106: device state comparing section
108: electric power consumption measuring section
110: electric power consumption comparing section
112: advice generating section
114: advice outputting section
116: collective control permitting section
118: collective control executing section
120: device information database (device information DB)
122: recording database (recording DB)

1. An electric power management device connected with a plurality of devices, comprising:
advice generating means for generating advice related to electric power saving;
advice outputting means for outputting the advice; and
control executing means for collectively carrying out controls of the respective plurality of devices in accordance with the advice.

2. An electric power management device as set forth in claim 1, further comprising state obtaining means for obtaining a state of at least one of the plurality of devices,
the advice generating means generating the advice in accordance with the state obtained by the state obtaining means.

3. The electric power management device as set forth in claim 1, wherein:
the electric power management device is further connected with another device that is different from any of the plurality of devices;
the electric power management device further comprises state obtaining means for obtaining a state of the another device; and
the advice generating means generates the advice in accordance with the state obtained by the state obtaining means.

4. The electric power management device as set forth in claim 2, wherein:
the advice generating means generates the advice in accordance with a transition of the state obtained by the state obtaining means.

5. An electric power management device as set forth in claim 1, further comprising measured value obtaining means for obtaining, from at least one of the plurality of devices, a measured value which has been measured by means of a sensor included in the at least one of the plurality of devices,
the advice generating means generating the advice in accordance with the measured value obtained by the state obtaining means.

6. The electric power management device as set forth in claim 1, wherein:
the electric power management device is further connected with another device that is different from any of the plurality of devices;
the electric power management device further comprises measured value obtaining means for obtaining a measured value which has been measured by means of a sensor included in the another device; and
the advice generating means generates the advice in accordance with the measured value obtained by the measured value obtaining means.

7. The electric power management device as set forth in claim 5, wherein:
the advice generating means generates the advice in accordance with a transition of the measured value obtained by the measured value obtaining means.

8. An electric power management device as set forth in claim 1, further comprising:
electric power consumption measuring means for measuring electric power consumptions in the respective plurality of devices; and
comparing means for making a comparison between (i) each of the electric power consumptions which have been measured by the electric power consumption measuring means and (ii) an electric power consumption in the past,
the advice generating means generating the advice in accordance with a result of the comparison by the comparing means.

9. The electric power management device as set forth in claim 1, wherein:
the electric power management device is further connected with a photovoltaic power generation device;
the electric power management device further comprises generated electric power measuring means for measuring an amount of electric power generated in the photovoltaic power generation device; and
the advice generating means generates the advice in accordance with the amount of electric power generated which has been measured by the generated electric power measuring means.

10. The electric power management device as set forth in claim 1, wherein:
the advice outputting means transmits the advice to a portable device carried by a user.

11. An electric power management method carried out by an electric power management device connected with a plurality of devices, comprising:
generating advice related to electric power saving;
outputting the advice; and
carrying out controls of the respective plurality of devices collectively in accordance with the advice.

12. An electric power management system comprising an electric power management device recited in claim 1 and the plurality of devices.

13. A house comprising an electric power management system recited in claim 12.

14. A program for (i) causing an electric power management device recited in claim 1 to operate and (ii) causing a computer to function as each means of the electric power management device.

15. A computer-readable recording medium in which a program recited in claim 14 is recorded.
